SEQUENCE LISTING (26 sequences)

SEQ ID NO: 1 - protein, 336 aa, Pseudomonas stutzeri
MLPKLVITHRVHDEILQLLAPHCELMTNQTDSTLTREEILRRCRDAQAMMAFMPDRVDADFLQACPELRVVGCALKGFDNFDVDACTARGVWLTFVPDLLTVPTAELAIGLAVGLGRHLRAADAFVRSGEFQGWQPQFYGTGLDNATVGILGMGAIGLAMADRLQGWGATLQYHEAKALDTQTEQRLGLRQVACSELFASSDFILLALPLNADTQHLVNAELLALVRPGALLVNPCRGSVVDEAAVLAALERGQLGGYAADVFEMEDWARADRPRLIDPALLAHPNTLFTPHIGSAVRAVRLEIERCAAQNIIQVLAGARPINAANRLPKAEPAAC

SEQ ID NO: 2 - protein, 335 aa, Acinetobacter radioresistens
MKQKIVLTHWVHPEIIDYLQSVADVVPNMTRDTMSRAELLERAKDADALMVFMPDSIDDDFLASCPKLKIVSAALKGYDNFDVDACTRRGIWFSIVPDLLTIPTAELTIGLLLGLTRHLAEGDRRIRTHGFNGWRPELYGTGLTGRTLGIIGMGAVGRAIAKRLSSFDMRVLYCDDIALNQEQEKAWNARQVSLDELLSSSDFVVPMLPMTPQTLHLLNAETIGTMRTGSYLINACRGSVVDELAVAEALESGKLAGYAADVFELEEWIRVDRPTAIPQELLTNTAQTFFTPHLGSAVDDVRFEIEQLAANNILQALTGQRPSDAINNPILEGVN

SEQ ID NO: 3 - protein, 333 aa, Alcaligenes faecalis
MKPRIVTTHRIHPDTLALLETAAEVISNQSDSTMSREEVLLRTNDADGMMVFMPDSIDADFLSACPNLKVIGAALKGYDNFDVEACTRHGIWFTIVPDLLTSPTAELTIGLLLSITRNMLQGDNYIRSRQFNGWTPRFYGTGLTGKTAGIIGTGAVGRAVAKRLAAFDMQIQYTDPQPLPQESERAWNASRTSLDQLLATSDFIIPMLPMSSDTHHTINARALDRMKPGAYLVNACRGSIVDERAVVHALRTGHLGGYAADVFEMEEWARPDRPHSIPDELLDPALPTFFTPHLGSAVKSVRMEIEREAALSILEALQGRIPRGAVNHVGAGR

SEQ ID NO: 4 - protein, 332 aa, Cyanothece sp. CCY0110
MSQKPKVVITHWIHPEVIDYLNPYCELILNQTKETLSREEVINRSRNAQGLMVFMPDHIDVKFLEACPNLKVISGALRGYDNFDVEACTKHNIWFTIVPDLLAAPTAELTIGLLIILARRMLEGDRLIRSDNFQGWKPQLYGTGLLNKSLGIIGMGKLGKALAKRLVGFDMNLLYTDPISLTNQQEKDWKISKTSLEELLSKSDYVVLMVSLVPDTYHLINENTLKLMKPKSFLINPCRGSVVDENAIADAIKSGHLAGYAADVFEMEDWAIANRPKSINQTLLTDIKHTFFTPHLGSAINDVRREIAIEAAKNIIEVFSDNRPKSAINNII

SEQ ID NO: 5 - protein, 335 aa, Gallionella ferruginea
MKPKIVITSWVHPQTLDMLRPHCDVVANETRERLSREEIIKRCSDAVAVMTFMPDSIDDAFLAECPQLRLVACALKGYDNYDVAACTRRGVRITNVPDLLTIPTAELTVGLLIGLTRKVLQGDRFVRSGQFTGWRPMLYGAGLTGRTLGIIGMGAVGRAIAARLQGYEMELLYTDPQPLPPELEARLGLRKVGLVQLLAESDYVVPMVPYTQDTLHMINAASLSIMKPGAYLVNTCRGSVVDEKAVADALDSGKLAGYAADVFELEEWMRPDRPESISERLLSNTELTLFTPHIGSAVDTVRLAIEMEAATNILQVLKGQIPQGAINHPLDKVAV

SEQ ID NO: 6 - protein, 336 aa, Janthinobacterium sp. Marseille
MKPKIVITHWVHPEIVEMLSSVAEVVTNDTLETLPREELLRRSKDADAVMAFMPDSVDDSFLAACPKLKIVFAALKGYDNFDVDACTKRGVWFGIVPDLLTVPTAELTVGLLLGLTRHVMAGDDHVRSGTFHGWRPKLYGAGLAGSTIGIIGMGRVGKAIAKRLSGFEMNAVYCDSVPLNPVDEQAWNARQVSFDELLTCSDFVVPMLPMTSDTFHLIDAHAISKMRRGSYLLNTSRGSVVDENAVVEALNQGHLAGYAADVFEMEEWARPDRPLTVPQALLNNRTQTLFTPHVGSGVKKVRLEIERYSAHSILQALAGQRPDGALNEPLKASVAA

SEQ ID NO: 7 - protein, 336 aa, Klebsiella pneumoniae
MLPKLVITHRVHDEILQLLAPHCELVTNQTDSTLTREEILRRCRDAQAMMAFMPDRVDADFLQACPELRVVGCALKGFDNFDVDACTARGVWLTFVPDLLTVPTAELAIGLAVGLGRHLRAADAFVRSGEFQGWQPQFYGTGLDNATVGILGMGAIGLAMAERLQGWGATLQYHEAKALDTQTEQRLGLRQVACSELFASSDFILLALPLNADTQHLVNAELLALVRPGALLVNPCRGSVVDEAAVLAALERGQLGGYAADVFEMEDWARADRPRLIDPALLAHPNTLFTPHIGSAVRAVRLEIERCAAQNIIQVLAGARPINAANRLPKAEPAAC

SEQ ID NO: 8 - protein, 336 aa, Marinobacter algicola
MKPRVVITHRVHDSILASLEPHCELITNQSAVTLPPDSVRARAATADAMMAFMPDRVSEEFLVACPDLKVIGAALKGFDNFDVDACTRHGVWLTFVPDLLTVPTAELTVGLTIGLIRQIRPADQFVRSGEFQGWQPQFYGLGIEGSTIGIVGMGAIGKAVATRLQGWGARVLYSQPESLPAAEEGALGLSRSELDDLLAESDIVILALALNEHTLHTLNADRLRQMKRGSFLINPCRGSVVDEAAVLQSLTYGHLSGYAADVFEMEDWARPDRPQRIDPALLAHPNTLFTAHTGSAVRDVRFAIELRAADNILQALRGHQPQDAVNSPLEPKGTVC

SEQ ID NO: 9 - protein, 339 aa, Methylobacterium extorquens
MRFKVVVTNPVFPETREILEGLCDVDINPGPEPWPAAEVRARCSDADALLAFMTDCVDAGFLEACPRLKVVACALKGWDNFDVEACTRSGIWLTAVPDLLTEPTAELAVGLAIGLCRNVVAGDRAVRAGFDGWRPRLYGSGLYGSVVGVAGMGKVGRAITRRLKGFGARELLYFDEQALPASAEAELGACRVSWDTLVGRSDVLILALPLTPDTRHMLDAAALAAASPGLRIVNAGRGSVVDEAAVAEALAEGRLGGYAADVFEMEDWALDDRPRRIAPGLLTVEDRTLFTPHLGSGVVDTRRRIEAAAAHNLLDALKGLVPADSINHPESLRGFDGAN

SEQ ID NO: 10 - protein, 332 aa, Nostoc sp. PCC 7120
MKPKVVITNWVHPEVIELLKPSCEVIANPSKEALSREEILQRAKDAEALMVFMPDTIDEAFLRECPKLKIIAAALKGYDNFDVAACTHRGIWFTIVPSLLSAPTAEITIGLLIGLGRQMLEGDRFIRTGKFTGWRPQFYSLGLANRTLGIVGMGALGKAIAGRLAGFEMQLLYSDPVALPPEQEATGNISRVPFETLIESSDFVVLVVPLQPATLHLINANTLAKMKPGSFLINPCRGSVVDEQAVCKALESGHLAGYAADVFEMEDWYRSDRPHNIPQPLLENTKQTFFTPHIGSAVDELRHNIALEAAQNILQALQGQKPQGAVNYLRES

SEQ ID NO: 11 - protein, 331 aa, Oxalobacter formigenes
MNKQKVVLTHWVHPEIVEMLQEKTDVVANLSRKTFTRDELLERAAAADALMAFMPDCIDEDFLKACPKLKVIGAALKGYDNFDVKACTERGVWLTIAPDLLTIPTAELTVGLVLAITRNMLEGDRHIRSGQFNGWRPELYGLGLHKRTAGIIGMGFVGKAVAERLKGFGMDILYADQSPLSQEEERELGLTRTGLPQLMHSSDVVIPLLPLTEQTFHLFDKDILGQMKQGSYLVNACRGSVVDEKAVVHSLKTGQLAGYAADVFEMEDWIRSDRPREIPQELLDNTAQTFFTPHLGSAVDEIRIEIERYCATSILQALAGDIPDGRVNDIR

SEQ ID NO: 12 - protein, 328 aa, Streptomyces sviceus
MVTHWIHPEVVDYLRRFCDPVVPVETEVLGRRQCLELAADADALIMCMADRVDDDFLAQCPRLRVISTVVKGYDNFDAEACARRGVWLTVLPDLLTAPTAELAVTLAVALGRRIREGDALMRSGRYDGWRPVLYGTGLYRSRVGVVGMGRLGRAVARRLSGFEPSEVLYYDKQPLGASEERRLGVRAAGLEELMGRCQVVLSLLPLAMDTRHLIGSDAIAAARPGQLLVNVGRGSVVDEDAVAAALDCGPLGGYAADVFGCEDLTAPGHLREVPRRLLTHPRTLLTPHLGSAVDVIRRDMEIAAAHQVEQALSGRVPDHEVTAGLLRE

SEQ ID NO: 13 - protein, 336 aa, Thioalkalivibrio sp. HL-EbGR7
MLPKLVITHRVHDEILQLLAPHCELMTNQTDSTLPREEILRRCRDAQAMMAFMPDRVDADFLQACPELRVVGCALKGFDNFDVDACTARGVWLTFVPDLLTVPTAELAIGLAVGLGRHLRAADAFVRSGEFQGWQPQFYGTGLDNATVGILGMGAIGLAMADRLQGWGATLQYHEAKALDTQTEQRLGLRRVACSELFASSDFILLALPLNADTQHLVNAELLALVRPGALLVNPCRGSVVDEAAVLAALERGQLGGYAADVFEMEDWARADRPRLIDPALLTHPNTLFTPHIGSAVRAVRLEIERCAAQNIIQVLAGARPINAANRLPKAEPAAC

SEQ ID NO: 14 - protein, 331 aa, Xanthobacter flavus
MARKTIVTNWVHPEVLDLLSTRGPAEANTTREPWPRDEIIRRAHGADAMLAFMTDHVDAAFLDACPELKIVACALKGADNFDMEACRARKVAVTIVPDLLTAPTAELAVGLMITLGRNLLAGDRLIRERPFAGWRPVLYGTGLDGAEVGIVGMGAVGQAIAHRLRPFRCRLSYCDARPLSPAAEDAQGLLRRDLADLVARSDYLVLALPLTPASRHLIDAAALAGMKPGALLINPARGSLVDEAAVADALEAGHLGGYAADVFETEDWARPDRPAAIEARLLAHPRTVLTPHIGSAVDSVRRDIALAAARDILRHLDGLQQDPPSRDRSAA

SEQ ID NO: 15 - protein, 10 aa, Artificial Sequence
  Synthetic
VGILGMGAIG

SEQ ID NO: 16 - protein, 16 aa, Artificial Sequence
  Synthetic
XPGALLVNPCRGSVVD

SEQ ID NO: 17 - protein, 6 aa, Artificial Sequence
  Synthetic
RGSVVD

SEQ ID NO: 18 - protein, 11 aa, Artificial Sequence
  Synthetic
GWQPQFYGTGL

SEQ ID NO: 19 - protein, 11 aa, Artificial Sequence
  Synthetic
GWXPXXYXXGL

SEQ ID NO: 20 - DNA, 1011 bp, Pseudomonas stutzeri
atgctgccgaaactcgttataactcaccgagtacacgatgagatcctgcaactgctggcgccacattgcgagctgatgaccaaccagaccgacagcacgctgacgcgcgaggaaattctgcgccgctgtcgcgatgctcaggcgatgatggcgttcatgcccgatcgggtcgatgcagactttcttcaagcctgccctgagctgcgtgtagtcggctgcgcgctcaagggcttcgacaatttcgatgtggacgcctgtactgcccgcggggtctggctgaccttcgtgcctgatctgttgacggtcccgactgccgagctggcgatcggactggcggtggggctggggcggcatctgcgggcagcagatgcgttcgtccgctctggcgagttccagggctggcaaccacagttctacggcacggggctggataacgctacggtcggcatccttggcatgggcgccatcggactggccatggctgatcgcttgcagggatggggcgcgaccctgcagtaccacgaggcgaaggctctggatacacaaaccgagcaacggctcggcctgcgccaggtggcgtgcagcgaactcttcgccagctcggacttcatcctgctggcgcttcccttgaatgccgatacccagcatctggtcaacgccgagctgcttgccctcgtacggccgggcgctctgcttgtaaacccctgtcgtggttcggtagtggatgaagccgccgtgctcgcggcgcttgagcgaggccagctcggcgggtatgcggcggatgtattcgaaatggaagactgggctcgcgcggaccggccgcggctgatcgatcctgcgctgctcgcgcatccgaatacgctgttcactccgcacatagggtcggcagtgcgcgcggtgcgcctggagattgaacgttgtgcagcgcagaacatcatccaggtattggcaggtgcgcgcccaatcaacgctgcgaaccgtctgcccaaggccgagcctgccgcatgttga

SEQ ID NO: 21 - DNA, 56 bp, Artificial Sequence
  Synthetic
ggggacaagtttgtacaaaaaagcaggctaaatgctgccgaaactcgttataactc

SEQ ID NO: 22 - DNA, 48 bp, Artificial Sequence
  Synthetic
ggggaccactttgtacaagaaagctgggtatcaacatgcggcaggctc

SEQ ID NO: 23 - DNA, 25 bp, Artificial Sequence
  Synthetic
atgctgccgaaactcgttataactc

SEQ ID NO: 24 - DNA, 18 bp, Artificial Sequence
  Synthetic
tcaacatgcggcaggctc

SEQ ID NO: 25 - DNA, 25 bp, Artificial Sequence
  Synthetic
atgctgccgaaactcgttataactc

SEQ ID NO: 26 - DNA, 19 bp, Artificial Sequence
  Synthetic
ctgcaagcgatcagccatg

(19) United States
(12) Patent Application Publication
(10) Pub. No.: US 2014/0069008 A1
(43) Pub. Date: Mar. 13, 2014

(54) PLANT CULTIVATION SYSTEM UTILIZING PHOSPHITE AS A NUTRIENT AND AS A CONTROL AGENT FOR WEEDS AND ALGAE

(71) Applicants: Luis Rafael Herrera-Estrella, Irapuato (MX); Damar Lizbeth López-Arredondo, Irapuato (MX)

(72) Inventors: Luis Rafael Herrera-Estrella, Irapuato (MX); Damar Lizbeth López-Arredondo, Irapuato (MX)

(73) Assignee: Centro de Investigacion y de Estudios Avanzados del Instituto Politecnico Nacional (CINVESTAV), Col. San Pedro Zacatenco (MX)

(21) Appl. No.: 13/992,640

(22) PCT Filed: Dec. 7, 2011
(86) PCT No.: PCT/IB11/03203

§ 371 Date: Nov. 26, 2013

Related U.S. Application Data
(60) Provisional application No. 61/567,590, filed on Dec. 6, 2011.
(60) Provisional application No. 61/488,500, filed on May 20, 2011.
(60) Provisional application No. 61/420,735, filed on Dec. 7, 2010.

(51) Int. Cl. A01G 1/00

(52) U.S. Cl. CPC A01G 1/001
USPC 47/59 R; 47/58.1 R

(57) ABSTRACT

A plant cultivation system, including methods, apparatus, plants, and compositions, for utilizing phosphite as a nutrient to support growth of a transgenic plant and as a control agent for unwanted organisms, such as weeds and/or algae, among others. In an exemplary method, an effective amount of phosphite is applied to a substrate, and/or to foliage above the substrate, to enhance growth of a transgenic plant and/or to act as a weed-control agent that kills weeds and/or directly suppresses growth of weeds near the transgenic plant. In another exemplary method, soil is tested for a content of phosphate, and an effective amount of phosphite for supporting growth of a transgenic plant and controlling weeds is selected and applied based on the content of phosphate. In yet another exemplary method, phosphite is used to control algae in a hydroponic system.

### CROSS-REFERENCES TO PRIORITY APPLICATIONS

This application is based upon and claims the benefit under 35 U.S.C. §119(e), the Paris Convention priority right, and any and all other applicable law of U.S. Provisional Patent Application Ser. No. 61/420,735, filed Dec. 7, 2010; U.S. Provisional Patent Application Ser. No. 61/488,500, filed May 20, 2011; and U.S. Provisional Patent Application Ser. No. 61/567,590, filed Dec. 6, 2011. These priority applications are incorporated herein by reference in their entirety for all purposes.

### CROSS-REFERENCE TO OTHER MATERIAL

This application incorporates herein by reference PCT Patent Application No. WO 2010/058298 A2, published May 27, 2010.

### INTRODUCTION

Problems with soil fertility and weed growth have led to excessive applications of phosphate (Pi) as a fertilizer to stimulate growth of desired plants, and herbicides to control unwanted plants (i.e., weeds). Use of these substances increases production costs and food prices and creates critical environmental problems. For example, the price of phosphate is rapidly increasing, with current high-grade reserves predicted to last only 50 to 100 years if present use is maintained. Even worse, the environmental cost of excessive phosphate fertilization is incalculable: phosphate runoff into rivers, lakes, and the ocean induces algal blooms that create oxygen-depleted “dead zones.” Excessive use of herbicides has produced highly resistant weeds in many regions of the world. The need for alternative approaches to fertilization and weed control is urgent.

PCT Patent Application No. WO 2010/058298 A2 to Herrera-Estrella et al. describes transgenic plants capable of growing on phosphite (Phi) as a source of phosphorus. Improved cultivation systems are needed to exploit the transgenic plants.

### SUMMARY

The present disclosure provides a plant cultivation system, including methods, apparatus, plants, and compositions, for utilizing phosphite as a nutrient to support growth of a transgenic plant and as a control agent for unwanted organisms, such as weeds and/or algae, among others. In an exemplary method, an effective amount of phosphite is applied to a substrate, and/or to foliage above the substrate, to enhance growth of a transgenic plant and/or to act as a weed-control agent that kills weeds and/or directly suppresses growth of weeds near the transgenic plant. In another exemplary method, soil is tested for a content of phosphate, and an effective amount of phosphite for supporting growth of a transgenic plant and controlling weeds is selected and applied based on the content of phosphate. In yet another exemplary method, phosphite is used to control algae in a hydroponic system.

### BRIEF DESCRIPTION OF THE DRAWINGS

FIG. 1 is a series of fragmentary schematic views of an area of land cultivated under various conditions to illustrate the advantages of an exemplary plant cultivation system utilizing phosphite as a nutrient and a weed-control agent, in accordance with aspects of the present disclosure.

FIG. 2 is a schematic view of another exemplary plant cultivation system, a hydroponic system, utilizing phosphite as a nutrient and an algae-control agent, in accordance with aspects of the present disclosure.

FIG. 3 is a flowchart illustrating an exemplary method of plant cultivation with phosphite, in accordance with aspects of the present disclosure.

FIG. 4 presents exemplary data illustrating stable insertion and expression of a ptxD gene in Arabidopsis transgenic lines, in accordance with aspects of the present disclosure.

FIG. 5 presents exemplary photographic data for growth experiments performed with wild-type plants and transgenic plants expressing a phosphite oxidoreductase, in accordance with aspects of the present disclosure.

FIG. 6 presents exemplary photographic data for wild-type Arabidopsis and tobacco plants grown in media supplemented with phosphate or phosphite, in accordance with aspects of the present disclosure.

FIG. 7 is a pair of graphs presenting exemplary data for biomass production and phosphorus content of wild-type and transgenic plants grown in a solid substrate, in accordance with aspects of the present disclosure.

FIG. 8 presents exemplary data for detection and expression of a ptxD gene in transgenic tobacco lines, in accordance with aspects of the present disclosure.

FIG. 9 presents exemplary photographic data for use of phosphite as a sole source of phosphorus by transgenic tobacco plants, in accordance with aspects of the present disclosure.

FIG. 10 presents exemplary data for productivity, photosynthesis, and phosphite content of wild-type and transgenic tobacco plants fertilized with phosphate or phosphite, in accordance with aspects of the present disclosure.

FIG. 11 presents exemplary data for the effect of phosphorus availability on the development of wild-type and transgenic plants, in accordance with aspects of the present disclosure.

FIG. 12 presents exemplary photographic data illustrating use of phosphite to achieve fertilization and weed control for transgenic plants, in accordance with aspects of the present disclosure.

FIG. 13 presents exemplary data for biomass production in competition experiments between transgenic tobacco plants and different weeds, in accordance with aspects of the present disclosure.

FIG. 14 presents exemplary data illustrating the effectiveness of phosphite for controlling different weed species, in accordance with aspects of the present disclosure.

FIG. 15 presents exemplary photographic data for a transgenic tobacco line modified to oxidize phosphite to phosphate and thereby use phosphite as a phosphorus source, and a control (wild-type) line of tobacco plant, each cultivated in agricultural soil for 31 days after germination without added phosphorus, or with the soil amended with phosphate or phosphite, in accordance with aspects of the present disclosure.

FIG. 16 presents exemplary data for the height of the transgenic and control lines of FIG. 15, each cultivated as in FIG. 15 and measured 68 days after germination, in accordance with aspects of the present disclosure.

FIG. 17 presents exemplary photographic data for the transgenic and control lines of FIG. 15, each cultivated as in FIG. 15 for 74 days after germination, in accordance with aspects of the present disclosure.

FIG. 18 presents exemplary data for the height of the transgenic and control lines of FIG. 15, each cultivated as in FIG. 15 and measured 74 days after germination, in accordance with aspects of the present disclosure.

FIG. 19 presents exemplary data for the leaf biomass, stem biomass, and total biomass of the transgenic and control lines of FIG. 15, each cultivated as in FIG. 15 and analyzed 75 days after germination, in accordance with aspects of the present disclosure.

FIG. 20 presents exemplary data for capsule biomass and seed biomass produced by the transgenic and control lines of FIG. 15, each cultivated as in FIG. 15 and analyzed four months after germination, in accordance with aspects of the present disclosure.

### DETAILED DESCRIPTION

The present disclosure provides a plant cultivation system, including methods, apparatus, plants, and compositions, for utilizing phosphite as a nutrient to support growth of a transgenic plant and as a control agent for unwanted organisms, such as weeds and/or algae, among others. In an exemplary method, an effective amount of phosphite is applied to a substrate, and/or to foliage above the substrate, to enhance growth of a transgenic plant and/or to act as a weed-control agent that kills weeds and/or directly suppresses growth of weeds near the transgenic plant. In another exemplary method, soil is tested for a content of phosphate, and an effective amount of phosphite for supporting growth of a transgenic plant and controlling weeds is selected and applied based on the content of phosphate. In yet another exemplary method, phosphite is used to control algae in a hydroponic system.

An exemplary method is provided for cultivating a transgenic plant that has been modified genetically to express an enzyme that catalyzes oxidation of phosphite to phosphate. In the method, the transgenic plant is disposed in a substrate having a content of available phosphate low enough to limit plant growth. An effective amount of phosphite is applied to the substrate, and/or to foliage above the substrate, to enhance growth of the transgenic plant and to act as a weed-control agent that kills weeds and/or directly suppresses growth of weeds near the transgenic plant.

Another exemplary method is provided for cultivating a transgenic plant that has been modified genetically to express an enzyme that catalyzes oxidation of phosphite to phosphate, with the enzyme being expressed at a level sufficient for the transgenic plant to use phosphite as a nutrient for growth. In the method, the transgenic plant may be disposed in a substrate having a content of available phosphate that is not limiting for weed growth. An effective amount of phosphite may be applied to the substrate, and/or to foliage above the substrate, to act as a weed-control agent that kills weeds and/or directly suppresses growth of weeds near the transgenic plant.

Yet another exemplary method is provided for cultivating a transgenic plant that has been modified genetically to express an enzyme that catalyzes oxidation of phosphite to phosphate. In the method, soil may be tested to determine a content of phosphate. An effective amount of phosphite may be selected for use as a weed-control agent based on the content of phosphate. The effective amount of phosphite may be applied to the soil, and/or to foliage above the soil. The transgenic plant may be grown in the soil.

A method of increasing the weed-control potency of phosphite for an area of soil is provided. In the method, a first crop of a transgenic plant may be cultivated in an area of soil, with the transgenic plant being modified genetically to express an enzyme that catalyzes oxidation of phosphite to phosphate. An effective amount of phosphite may be applied to the area of soil to enhance growth of the first crop and to provide a weed-control agent that kills weeds and/or directly suppresses growth of weeds near the transgenic plant. The steps of cultivating and applying may be repeated with a second crop of a transgenic plant modified genetically to express an enzyme that catalyzes oxidation of phosphite to phosphate.

A method is provided for hydroponically cultivating a transgenic plant that has been modified genetically to express an enzyme that catalyzes oxidation of phosphite to phosphate. In the method, the transgenic plant may be cultured in a liquid or semi-solid medium of a hydroponic system. The medium may contain an effective amount of phosphite to support growth of the plant and to act as an algae-control agent that kills algae and/or suppresses growth of algae in the medium.

The plant cultivation systems of the present disclosure may offer substantial advantages including (1) fertilization and weed control with the same compound, (2) a lower probability for genesis of resistant weeds, (3) hydroponic cultivation with fewer algae, (4) fertilization with less total phosphorus, and/or (5) less phosphate runoff, among others.

Further aspects of the present disclosure are described in the following sections: (I) definitions, (II) exemplary plant cultivation systems utilizing phosphite, (III) exemplary methods of plant cultivation with phosphite, and (IV) examples.

### I. DEFINITIONS

Technical terms used in this disclosure have the meanings that are commonly recognized by those skilled in the art. However, the following terms may have additional meanings, as described below.

Plant—a member of the Plantae kingdom of eukaryotic organisms, which may be described as a tree, bush, grass, shrub, herb, vine, fern, moss, or a combination thereof, among others. A plant typically possesses cellulose cell walls and is capable of carrying out photosynthesis. The plant may be a vascular plant. In some embodiments, the plant may be an annual or a perennial. The plant may be a flowering plant, such as a monocotyledon or a dicotyledon. In some embodiments, the plant may produce a grain, tuber, fruit, vegetable, nut, seed, fiber, or a combination thereof, among others. Furthermore, the plant may be a crop plant, which may be cultivated in a field. Exemplary crop plants that may be suitable for generation of transgenic plants according to the present disclosure include tobacco (e.g., N. tabacum), potato, maize, rice, wheat, alfalfa, chili pepper, agave, broccoli, soybean, tomato, sugarcane, and the like.

Transgenic plant—a genetically modified plant. The plant may include a nucleic acid construct, which may be integrated into the plant's genome. The construct may be heritable, that is, passed on to successive generations of the transgenic plant. A transgenic plant interchangeably may be described as a transgenic line of plants.

Phosphite oxidoreductase—any enzyme that catalyzes oxidation of phosphite to phosphate with substantial efficiency. The enzyme may be expressed at an effective level in a plant, which is any level capable of catalyzing oxidation of phosphite to phosphate with sufficient efficiency to enable the plant to use phosphite as a source of phosphorus to support plant growth. The effective level of the enzyme may support growth of the plant that is comparable (e.g., growth (such as total biomass) within about a factor of two), whether an equivalent amount of phosphate or phosphite is used as the source of phosphorus. In some cases, the effective level of the enzyme may support about the same plant growth, whether phosphite or phosphite is used as the phosphorus source, but with less phosphorus needed for the same growth with phosphite relative to phosphate, such as at least about 5%, 10%, or 25% less phosphorus, among others. Expression of the enzyme may be the result of genetic modification of a plant that cannot use phosphite as a source of phosphorus to support substantial plant growth, to produce a transgenic variety of the plant (a transgenic plant) that can use phosphite to support substantial growth.

The phosphite oxidoreductase may originate from an organism that can oxidize phosphite to phosphate. For example, the phosphite oxidoreductase may be a polypeptide of bacterial origin. The phosphite oxidoreductase may be expressed from any plant or non-plant promoter that is sufficiently active in a plant.

Phosphite dehydrogenase—a phosphite oxidoreductase that is a dehydrogenase. The phosphite dehydrogenase may be a polypeptide of bacterial origin. The phosphite dehydrogenase may include a PtxD polypeptide, which is any polypeptide that is (a) at least 90%, 95%, or completely identical to PtxD (SEQ ID NO:1; GenBank: AAC71709.1) of Pseudomonas stutzeri WM 88, (b) a derivative of PtxD of SEQ ID NO:1, (c) a homolog (i.e., a paralog or ortholog) of PtxD (SEQ ID NO:1) from the same or a different bacterial species or from a nonbacterial organism, or (d) a derivative of (c). Homologs of PtxD (SEQ ID NO:1) have substantial similarity to PtxD of Pseudomonas stutzeri, which may, for example, be determined by the BLASTp algorithm (e.g., program BLASTP 2.2.18+), as described in the following two references, which are incorporated herein by reference: Stephen F. Altschul, et al. (1997), “Gapped BLAST and PSI-BLAST: a new generation of protein database search programs,” Constructs Res. 25:3389-3402; and Stephen F. Altschul et al. (2005) “Protein database searches using compositionally adjusted substitution matrices,” FEBS J. 272:5101-5109. Examples of substantial similarity include at least 50%, 60%, 70%, or 80% sequence identity, a similarity score of at least 200 or 250, and/or an E-Value of less than 1e-40, 1e-60, or 1e-80, among others, using the blastp algorithm, with optimal alignment and, if needed, introduction of gaps.

Exemplary homologs of PtxD of Pseudomonas stutzeri may be provided by Acinetobacter radioresistens SK82 (SEQ ID NO:2; GenBank EET83888.1); Alcaligenes faecalis (SEQ ID NO:3; GenBank AAT12779.1); Cyanothece sp. CCY0110 (SEQ ID NO:4; GenBank EAZ89932.1); Gallionella ferruginea (SEQ ID NO:5; GenBank EES62080.1); Janthinobacterium sp. Marseille (SEQ ID NO:6; GenBank ABR91484.1); Klebsiella pneumoniae (SEQ ID NO. 7; Genbank ABR80271.1); Marinobacter algicola (SEQ ID NO:8; GenBank EDM49754.1); Methylobacterium extorquens (SEQ ID NO:9; NCBI YP_{—}003066079.1); Nostoc sp. PCC 7120 (SEQ ID NO:10; GenBank BAB77417.1); Oxalobacter formigenes (SEQ ID NO. 11; NCBI ZP_{—}04579760.1); Streptomyces sviceus (SEQ ID NO:12; GenBank EDY59675.1); Thioalkalivibrio sp. HL-EbGR7 (SEQ ID NO:13; GenBank ACL72000.1); and Xanthobacter flavus (SEQ ID NO:14; GenBank ABG73582.1), among others. Further aspects of PtxD homologs are described in U.S. Patent Application Publication No. 2004/0091985 to Metcalf et al., which is incorporated herein by reference. The phosphite dehydrogenase may have an amino acid sequence of at least 100, 200, or 300 amino acids, and/or representing the full dehydrogenase polypeptide, with at least about 50%, 60%, 80%, 90%, 95%, or 100% sequence identity to one or more of SEQ ID NOS:1-14.

Exemplary derivatives of PtxD of Pseudomonas stutzeri that may be suitable are described in U.S. Patent Application Publication No. 2004/0091985 and in U.S. Pat. No. 7,402,419 to Zhao et al., which are incorporated herein by reference. The derivatives may provide, for example, altered cofactor affinity/specificity and/or altered thermostability.

The phosphite dehydrogenase may contain a sequence region with sequence similarity or identity to any one or any combination of consensus motifs. The consensus motifs may include an NAD-binding motif having a consensus sequence of VGILGMGAIG (SEQ ID NO:15); a conserved signature sequence for the D-isomer-specific 2-hydroxyacid family with a consensus sequence of XPGALLVNPCRGSVVD (SEQ ID NO:16), where X is K or R, or a shorter consensus sequence within SEQ ID NO:16 of RGSVVD (SEQ ID NO:17); and/or a motif that may enable hydrogenases to use phosphite as a substrate, with a general consensus of GWQPQFYGTGL (SEQ ID NO:18), but that can be better defined as GWX₁PX₂X₃YX₄X₅GL (SEQ ID NO. 19), where X₁ is R, Q, T, or K, X₂ is A, V, Q, R, K, H, or E, X₃ is L or F, X₄ is G, F, or S, and X₅ is T, R, M, L, A, or S. Further aspects of consensus sequences found by comparison of PtxD and PtxD homologs are described in U.S. Patent Application Publication No. 2004/0091985 to Metcalf et al., which is incorporated herein by reference.

A phosphite dehydrogenase may (or may not) be a NAD-dependent enzyme with high specificity for phosphite as a substrate (e.g., Km ˜50 μM) and/or with a molecular weight of about 36 kilodaltons. The dehydrogenase enzyme may, but is not required to, act as a homodimer, and/or have an optimum activity at 35° C. and/or a pH of about 7.25-7.75.

ptxD coding region—a sequence encoding a PtxD polypeptide. An exemplary ptxD coding region for generation of a transgenic plant that uses phosphite as a phosphorus source is provided by ptxD of Pseudomonas stutzeri (SEQ ID NO:20; GenBank AF061070.1). In other examples, a ptxD coding region with at least 80% or 90% sequence identity to SEQ ID NO:20 may be utilized. In other examples, a coding region that encodes a polypeptide with at least about 50%, 60%, 80%, 90%, 95% or 100% identity to one or more of the polypeptides of SEQ ID NOS:1-14 may be utilized.

Phosphate—phosphoric acid (H₃PO₄), its dibasic form (H₂PO₄¹⁻), its monobasic form (HPO₄²⁻), its triply ionized form (PO₄³⁻), or any combination thereof. Phosphate may be provided as any suitable phosphate compound or combination of phosphate compounds. Exemplary forms of phosphate include phosphate salts of sodium, potassium, lithium, rubidium, cesium, aluminum, ammonium, calcium, or magnesium, or any combination thereof, among others. In phosphate, four oxygens are bonded directly to a phosphorus atom. Phosphate also or alternatively may be called “orthophosphate” and/or “inorganic phosphate” and may be abbreviated as “Pi.”

Phosphite—phosphorous acid (H₃PO₃), its conjugate base/singly ionized form (H₂PO₃¹⁻), or its doubly ionized form (HPO₃²⁻), or any combination thereof. In phosphite, three oxygens and one hydrogen are bonded directly to a phosphorus atom. Phosphite may be provided as any suitable phosphite compound or combination of phosphite compounds. Exemplary forms of phosphite include phosphite salts of sodium, potassium, lithium, rubidium, cesium, ammonium, aluminum, calcium, or magnesium, or any combination thereof, among others. Phosphite can be oxidized to phosphate. Phosphite also or alternatively may be called “inorganic phosphite” and/or orthophosphate, and may be abbreviated as “Phi.”

Control agent—a substance (e.g., phosphite) that kills and/or suppresses the growth of sensitive organisms, such as plants (i.e., a weed-control agent) and/or algae (i.e., an algae-control agent). The control agent has a direct negative effect on the survival and/or growth of sensitive organisms (e.g., weeds), which means that the negative effect does not require an insensitive (transgenic) plant as an intermediary and thus can occur whether or not the insensitive (transgenic) plant is present. In other words, a direct negative effect is different from an indirect negative effect created by selectively enhancing growth of only the transgenic plant. As disclosed herein, phosphite may have a direct negative effect on weeds (or other organisms) as a control agent, by killing and/or directly suppressing growth of the weeds. In some cases, the phosphite also may have an indirect negative effect on the weeds by selectively enhancing growth of the transgenic plant that is competing with the weeds for space, nutrients, light, water, etc.

The control agent may have a broad-spectrum toxicity for plants (except the transgenic plants disclosed herein), algae, and/or other organisms. The control agent interchangeably may be described as an herbicide, an algaecide, a fungicide, a bacteriocide, or any combination thereof.

The control agent may kill and/or directly suppress growth by any mechanism or combination of mechanisms that reduces the number, average size, and/or collective mass of the sensitive organisms. For example, the control agent may arrest or slow development of the organisms, reduce the rate of cell division of the organisms, promote death of cells of the organisms, reduce the size of the cells, inhibit reproduction, or a combination thereof, among others. Direct suppression of growth, killing, or both, by the control agent produces a substantial reduction in the collective biomass produced by the sensitive organisms and/or in the number of the sensitive organisms (e.g., weeds or algae), such as at least about a 50%, 75%, 90%, or 95% reduction (relative to the absence of the control agent under similar conditions). In some cases, the control agent may kill at least about 50%, 75%, 90%, or 95% of the sensitive organisms.

### II. EXEMPLARY PLANT CULTIVATION SYSTEMS UTILIZING PHOSPHITE

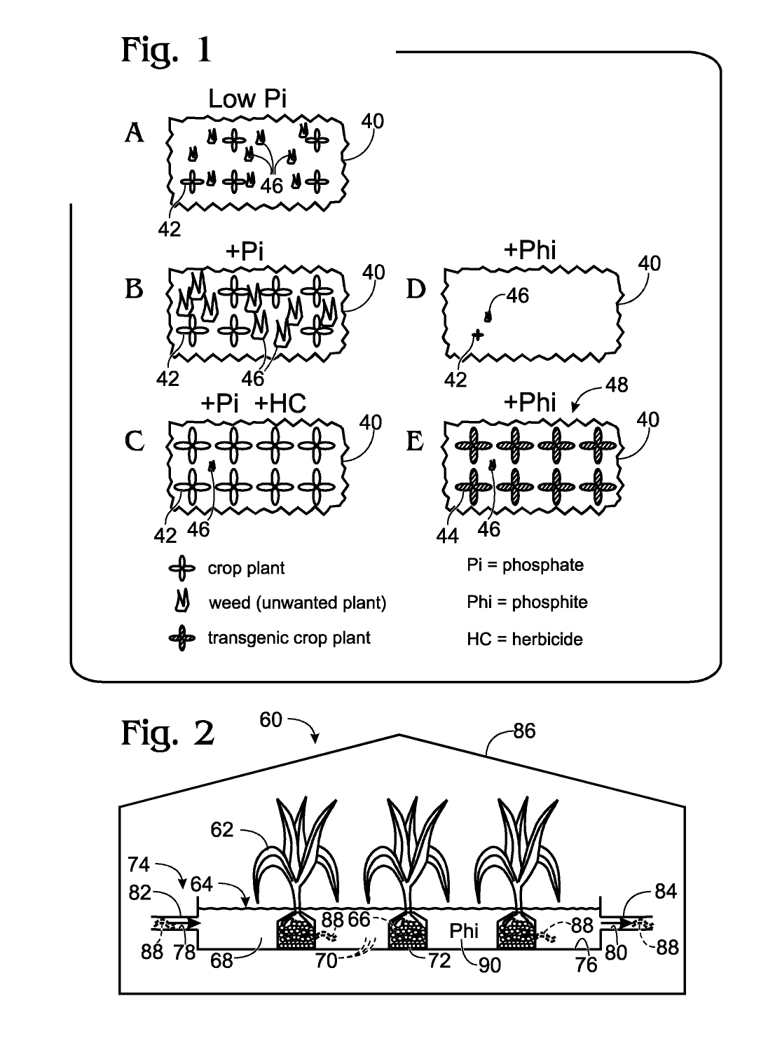

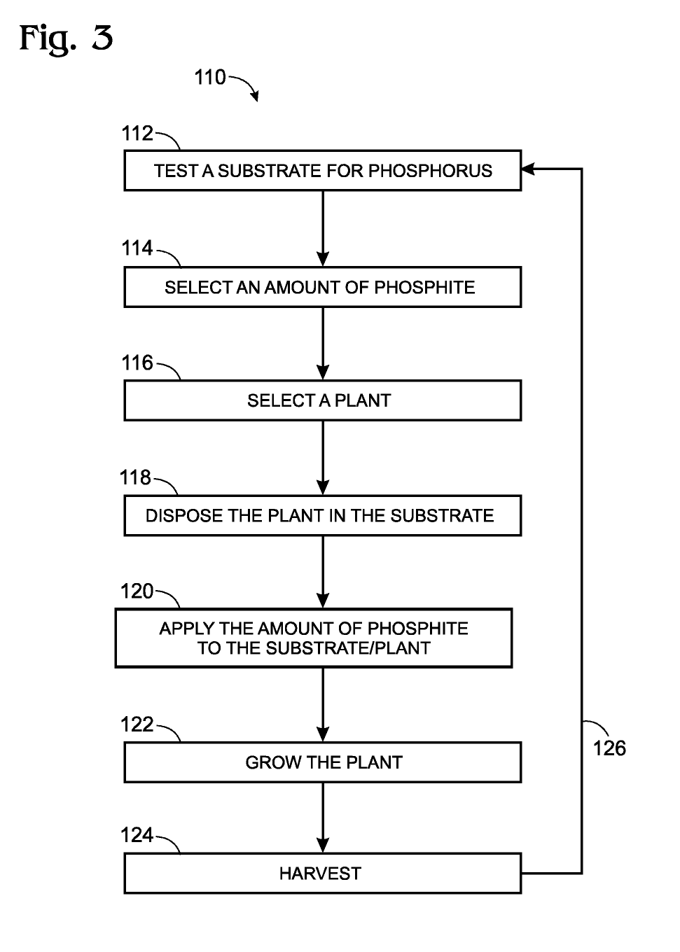

This section describes exemplary plant cultivation systems utilizing an effective amount of phosphite as a nutrient to support growth of a transgenic plant and as a control agent for weeds and/or algae; see FIGS. 1 and 2.

FIG. 1 shows a series of fragmentary schematic views (A-E) of an area of land or soil 40 (e.g., a field) cultivated under various conditions. Comparison of the number and size of crop plants 42, 44 relative to weeds 46 (i.e., other, undesired plants) under the various conditions illustrate the advantages of an exemplary plant cultivation system 48 (see FIG. 1E) utilizing phosphite as a nutrient to support growth of a transgenic crop plant and as a weed-control agent to kill weeds and/or directly suppress growth of the weeds.

FIG. 1A shows area 40 without any phosphorus supplementation. The soil in the area has a low content of available phosphate, which substantially limits the growth of crop plant 42 and weeds 46. The crop yield is low.

FIG. 1B shows area 40 cultivated with the addition of phosphate (Pi) fertilizer. Here, sufficient phosphate has been added such that phosphorus is no longer limiting for growth. However, weeds 46 compete with specimens of crop plant 42 for space, water, sunlight, and other nutrients. As a result, the presence of the weeds reduces the number and/or average size of the specimens of crop plant 42. Overall, the use of the phosphate fertilizer offers an improved, but lower than the maximal crop yield obtained in the absence of weeds.

FIG. 1C shows area 40 cultivated as in FIG. 1B, but with the addition of an herbicide (“HC”) for control of the weeds. The herbicide selectively kills and/or suppresses the growth of weeds 46, such that the number, size, and/or collective biomass of the weeds is reduced substantially, generally without a substantial negative effect on the growth of crop plant 42. As a result, competitive pressure from the weeds is substantially reduced or eliminated, and a high crop yield may be obtained from crop plant 42.

FIG. 1D shows area 40 cultivated with the addition of phosphite (Phi) instead of phosphate (compare with FIG. 1B). Here, the phosphite acts as a broad-spectrum herbicide that non-selectively kills and/or suppresses growth of nontransgenic crop plant 42 and weeds 46. The phosphite may substantially reduce the number, average size, and/or collective biomass of specimens of crop plant 42 (and weeds 46), resulting in a very low crop yield.

FIG. 1E shows area 40 cultivated with plant cultivation system 48, with phosphite added. Crop plant 42 is replaced by genetically modified crop plant 44, which is a transgenic variety of plant 42 that expresses an enzyme capable of catalyzing oxidation of phosphite to phosphate. Transgenic crop plant 44 is thus fertilized by the added phosphite. Also, the phosphite acts as a weed-control agent for weeds 46, as in FIG. 1D. As a result, a high crop yield may be obtained from modified crop plant 44. The cultivation system of FIG. 1E may have substantial advantages over that of FIG. 1C, including a reduced (or no) need for a separate weed-control agent, and a more environmentally friendly and sustainable approach to phosphorus fertilization and weed control.

FIG. 2 shows another exemplary plant cultivation system, a hydroponic system 60. The hydroponic system may be used to culture plants, such as a transgenic plant 62 capable of using a reduced form of phosphorus (e.g., phosphite) as a source of phosphorus for growth.

The hydroponic system is configured to culture plants in a liquid or semi-solid medium 64 (interchangeably termed a substrate), typically without soil. The plants, particularly roots 66 thereof, may be immersed in an aqueous nutrient solution 68 forming at least a liquid part of medium 64. Nutrient solution 68 may contain all of the mineral nutrients 70 required for growth of plant 62, such as nitrogen, phosphorus, potassium, calcium, magnesium, sulfur, boron, copper, iron, chlorine, manganese, molybdenum, and/or zinc, among others.

Medium 64 is shown in the depicted embodiment as a semi-solid medium including a matrix 72 in which the roots of the plants are disposed. The matrix may be inert, and may help support the plant. Exemplary materials for the matrix include sand, gravel, perlite, pumice, vermiculite, rock wool, clay pellets, or the like.

The hydroponic system may be equipped with a fluidics system 74 that contains nutrient solution 68. The fluidics system may be equipped with a container 76, such as a tank, that holds medium 64. The container may be described as a cultivation container that receives at least a lower portion of the transgenic plant 62 and/or that provides a reservoir of the nutrient solution for the transgenic plant. In some cases, the container may be at least partially open at the top, to allow the plant to project from the top of the container.

In any event, the container may be fluidically connected to one or more channels 78, 80 that carry portions of the nutrient solution to and from container 76, as indicated by arrows in the channels. For example, in the depicted embodiment, channel 78 provides an inlet through which additional nutrient solution can be added to the container, and channel 80 provides an outlet through which portions of the nutrient solution can be removed from the container. Each channel may, for example, be formed by a respective pipe 82, 84. The fluidic system also may include one or more pumps that drive fluid through the channels. In some cases, the fluidic system may be configured to recirculate the nutrient solution by action of the pump, such that portions of the nutrient solution flow from the container via the outlet and then re-enter the container via the inlet. In some cases, transgenic plant 62 may be disposed in a spaced relation to the container (e.g., supported above the container) and may receive the nutrient solution from the container by passive fluid flow (e.g., wicking).

The hydroponic system may be used to cultivate plants with the plants covered and/or enclosed. For example, the hydroponic system may include a building, such as a greenhouse 86, that encloses the plants and container 76.

A hydroponic system can provide an environment well-suited for unwanted aquatic organisms, such as algae. For example, surfaces of the hydroponic system, including surfaces of the plants themselves, can be colonized by algae 88. The algae may include microalgae, macroalgae, or both. In some cases, the algae may include green algae. In any event, the algae can reduce the efficiency of the hydroponic system substantially, such as by interfering with light transmission, impeding access of plant roots to water and nutrients, restricting flow of the nutrient solution (e.g., clogging pipes 82, 84), providing a haven for plant pathogens, and/or the like. The system can be cleaned periodically, to remove algae, but such cleaning can be costly, labor-intensive, and potentially harmful to plants under cultivation.

Hydroponic system 60 may use phosphite 90 in nutrient solution 68 as an algae-control agent. An effective amount of phosphite may be incorporated into the nutrient solution to support growth of transgenic plant 62, while providing control of algae 88. Phosphite may be present in excess over phosphate in the medium and/or nutrient solution, such at being present at a concentration that is at least about 2, 5, or 10 times the concentration of phosphate. Accordingly, plant 62 may grow with phosphite as its primary source of phosphorus. The phosphite may act as an algae-control agent that kills and/or suppresses growth of algae in the medium. Since the phosphite also can control other organisms, the phosphite also or alternatively may act as a weed-control agent (although weeds are not typically a problem for hydroponic system), a fungus-control agent, a bacteria-control agent, or any combination thereof.

The nutrient solution generally contains a detectable level of phosphate, whether or not added deliberately. For example, phosphate may be introduced by the water, since hydroponic systems typically use nondistilled water for preparation of the nutrient solution. Alternatively, or in addition, phosphate may be introduced by a matrix of the medium and/or by leaching from components of the fluidics system.

### III. EXEMPLARY METHODS OF PLANT CULTIVATION WITH PHOSPHITE

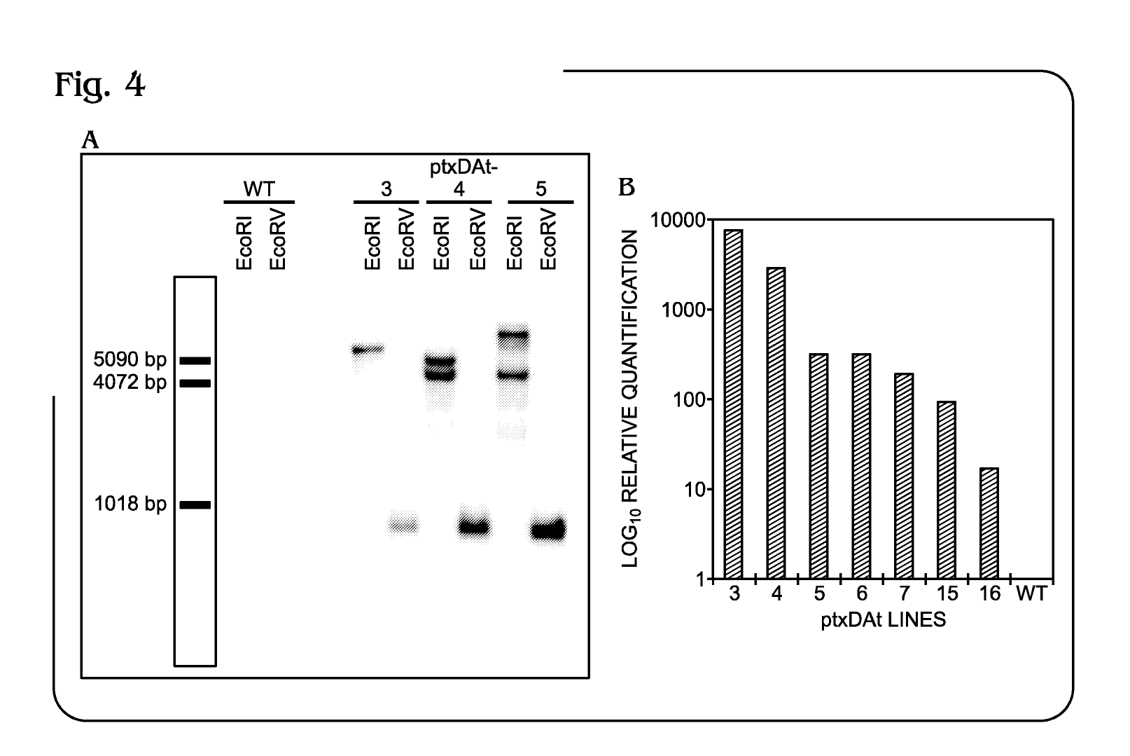

This section describes exemplary methods of plant cultivation utilizing phosphite as a nutrient to support growth of a transgenic plant and/or as a control agent for unwanted organisms, such as weeds and/or algae; see FIG. 3. In some embodiments, the methods may deplete phosphate progressively from soil, may increase the weed-control potency of phosphite for an area of soil, may culture plants hydroponically while controlling algae, may select an amount of phosphite based on a tested content of phosphate, or any combination thereof, among others.

FIG. 3 shows a flowchart illustrating an exemplary method 110 of cultivating a transgenic plant with phosphite. The steps presented may be performed in any suitable order and in any suitable combination. If steps are repeated, the steps may be repeated in any suitable series of combinations.

A substrate may be tested for phosphate, indicated at 112. The substrate may be any medium in and/or on which a transgenic plant is to be cultivated. The substrate may be soil (e.g., soil in a field), an at least substantially soil-less solid medium (e.g., a potting mix), a liquid or semi-solid medium for hydroponics, or the like.

A content of phosphorus in the substrate may be determined by testing. Phosphorus may be present in different chemical forms and complexes, only some of which may be available for plant uptake. Accordingly, different tests may be performed to measure the total phosphorus and/or phosphate content, particulated phosphorus and/or phosphate content, and/or available phosphorus and/or phosphate content, among others. The available content of phosphorus (generally as phosphate) may be different from the total content of phosphorus or phosphate, particularly with acidic or basic soils. The available content of phosphate corresponds to a portion or all of the total phosphorus that is released (generally as soluble phosphate) by exposure of the substrate to water under defined conditions. For example, a neutral soil (about pH 6 to 8) having an available phosphate content of about 20 parts per million (ppm) (or mg per kg of substrate) produces a phosphate solution of roughly 20 micromolar (20 μM) when saturated with water. The roots of a plant in the neutral soil take in phosphate from the 20 μM phosphate solution. In contrast, if the soil is acidic (pH<6) or basic (pH>8), a higher content of phosphate (e.g., about 50 ppm) is needed to generate the same concentration (20 μM) of phosphate solution in contact with the roots when the soil is saturated with water. The difference results at least in part from “unavailable” phosphate that is insoluble and/or precipitates at an acidic or basic pH and is thus not available for plant uptake.

The content of available phosphorus/phosphate may be limiting for plant growth. In other words, supplementing the content of available phosphorus/phosphate with additional phosphate enhances growth of plants cultivated in the substrate. An exemplary content of phosphorus/phosphate that limits plant growth may be less than about 5, 10, 20, or 40 ppm for a neutral soil, and less than about 25, 50, or 100 ppm for an acidic or basic soil, and less than about 10, 20, 40, or 100 μM for a hydroponic medium.

An amount of phosphite may be selected, indicated at 114, for application to the substrate and/or foliage above the substrate. The amount selected may be based on the content of phosphate determined by testing the substrate. The amount selected may be an effective amount to enhance growth of a transgenic plant disposed in the substrate and/or to act as a weed-control agent for the substrate. If the content of available phosphate is not limiting for growth, additional phosphite may not enhance plant growth and may act only as a weed-control agent.

Phosphite may be effective to control weeds (and/or algae) if plants (desired and unwanted (or algae)) are exposed to an equal or greater amount of phosphite than phosphate (e.g., a ratio of phosphite to phosphate of at least about 1:1, 2:1, 5:1, or 10:1, among others). Accordingly, a greater amount of phosphite may be selected if the content of available phosphate is relatively higher and a lesser amount may be selected if the content of available phosphate is relatively lower. The exposure may occur in the substrate (e.g., at the surface of roots of the plants), above the substrate (e.g., at the surface of foliage of the plants), or a combination thereof.

A plant may be selected for cultivation, indicated at 116. The plant may be a transgenic plant that has been genetically modified to enable use of phosphite as a source of phosphorus. The transgenic plant may have any of the characteristics disclosed elsewhere herein and/or in PCT Patent Application Publication No. WO 2010/058298 A2, published May 27, 2010, which is incorporated herein by reference.

The transgenic plant may be disposed in the substrate, indicated at 118. For example, seeds for the transgenic plant may be placed in and/or on the substrate and allowed to germinate. Alternatively, or in addition, regenerative plant parts and/or plantlets may be placed in and/or on the substrate. Regenerative plant parts include any part of a plant (e.g., tubers, cuttings, etc.) that can regenerate complete specimens of the transgenic plant. Plantlets include any immature specimens of the transgenic plant. In some cases, seeds, regenerative plant parts, and/or seedlings may be disposed in a hydroponic medium.

The amount of phosphite selected (at 114) may be applied to the substrate and/or to foliage above the substrate, indicated at 120. (Application of phosphite interchangeably may be termed adding phosphite.) The phosphite may be applied as a solid formulation, a liquid formulation, or a combination thereof, among others. For example, a solid or liquid formulation can be applied to the substrate and a liquid formulation to foliage. The amount of phosphite may be applied in a single application or two or more applications. The phosphite may be applied as a phosphite salt or a combination of phosphite salts, among others. For a hydroponic system, application of phosphite may be performed by including phosphite in a nutrient solution.

The transgenic plant (selected at 116) may be grown, indicated at 122. Growing the transgenic plant may include any procedure or combination of procedures that fosters plant growth, maturation, and/or reproduction. Exemplary procedures for growing a plant may include watering, spraying (e.g., with a pesticide or herbicide), fertilizing, weeding, pruning, tilling, or the like. Growing the transgenic plant may produce specimens of the transgenic plant that collectively form a crop.

The transgenic plant may be harvested, indicated at 124. Harvesting may include collecting one or more edible and/or useful portions (or all) of the crop grown at 122.

Method 110 may be repeated, indicated at 126, to produce a second crop. If repeated, the substrate may or may not be retested for phosphate. The content of phosphate, if tested again, may be lower because the first crop used some phosphate from the substrate for growth. Accordingly, phosphite may have a greater weed-control potency for the second crop relative to the first crop. In any event, the amount of phosphite selected may be the same or different from that used for the previous (first) crop. For example, a lesser amount of phosphite may be selected for the second crop than for the first crop, to keep the phosphite to phosphate ratio about the same for the first and second crops. In other cases, about the same amount of phosphite may be selected, which may produce better weed control for the second crop than for the first crop. The same or a different species of transgenic plant may be selected and grown for the second crop.

### IV. EXAMPLES

The following examples describe selected aspects of exemplary cultivation systems. These examples are intended for illustration and should not be interpreted as limiting the entire scope of the present disclosure.

### Example 1

### Experimental Results with Transgenic Plants and Weeds

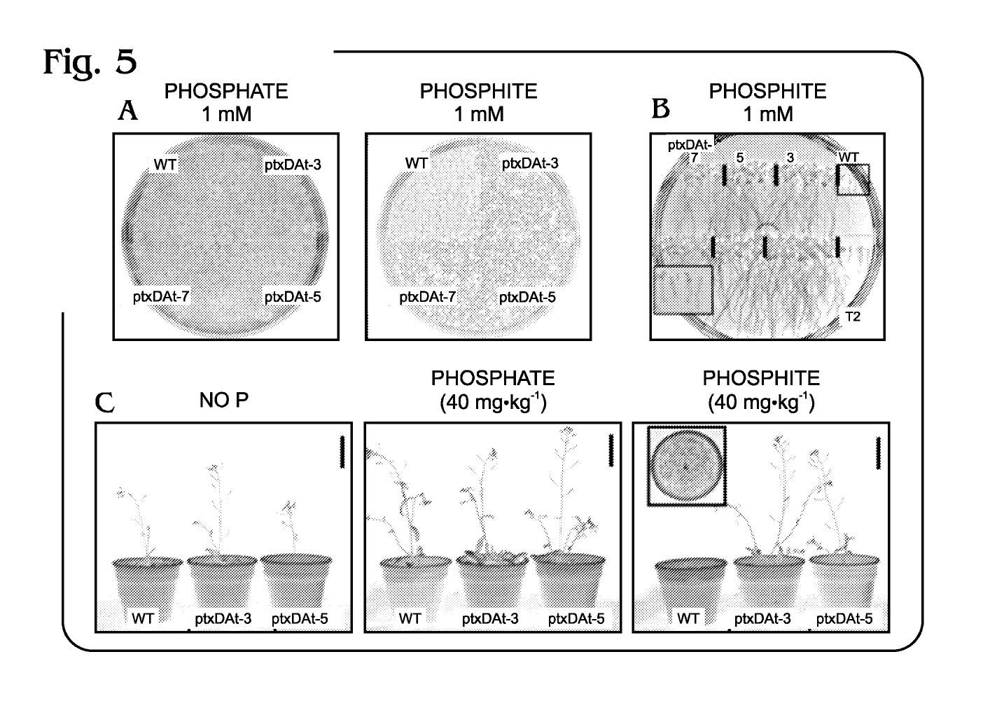

This example describes experimental results with exemplary cultivation systems that utilize phosphite for fertilization and weed control; see FIGS. 4-14.

### A. SUMMARY

Agriculture requires continuous input of orthophosphate (Pi)-based fertilizers and herbicides [1, 2]. However, since phosphorus (P) is a non-renewable resource and herbicides now face resistant weeds, these problems become two of the principal challenges for future agriculture [3-5]. A novel strategy is to engineer plants able to use alternative P sources not readily metabolized by microorganisms and weeds. Phosphite (Phi) has been proposed as a promising alternative P-fertilizer and as a non-selective herbicide [6, 7]. However its use has been hampered because Phi cannot be assimilated by plants [7]. Here, we report transgenic plants expressing a phosphite oxidoreductase [8] capable of completing their life cycle using Phi as a P source. Seed and biomass production of transgenic plants fertilized with Phi is similar to that obtained with Pi, whereas the growth of non-engineered plants is compromised, facilitating the design of a novel and effective fertilization and weed control system through the application of a single compound.

### B. INTRODUCTION

Drought, poor soil fertility and aggressive weeds are some of the major constraints in meeting the increasing demand for worldwide food production. Starting with the green revolution in the 1960s, higher yields have been paralleled by a steady increase in the use of fertilizers and herbicides [1, 2]. The case of fertilizers based on orthophosphate (Pi) deserves special attention, because in addition to its essential role in central metabolic processes for all living organisms [9], P is a non-renewable resource with a rapidly increasing price, for which current high-grade reserves are predicted to last only 50 to 100 years if present use is maintained [3-5]. Pi represents a key determinant for plant productivity because it is the only chemical form of P that can be assimilated by plants to meet their nutritional requirements. However, Pi is below optimal levels for growth of plants in about 67% of cultivated soils [10]. Low Pi availability is mainly due to its high reactivity with soil components and rapid conversion by soil bacteria into organic forms that are not readily available for plant uptake, and several estimates suggest that only about 20% of the Pi in the applied fertilizer is used by cultivated plants [11, 12]. This situation is further aggravated by the constant competition of weeds for essential resources, most critically for water and nutrients, such as Pi present in limiting amounts [2]. Moreover, since herbicides face a severe challenge from highly resistant weeds in many regions of the world, these problems have led to excessive applications of both Pi fertilizers and herbicides, which not only increase production costs and food prices, but also create critical environmental problems [2, 5, 13].

With P reserves rapidly declining, both national and international research programs have focused increasing interest on the development of alternative fertilization schemes to reduce Pi application, cost-effective technologies for recycling P from all possible sources and the design of more effective weed-management systems [3, 9, 14]. Because Pi cannot be substituted in plant nutrition, relatively little attention has been given to the use of other chemical forms of P to formulate effective and environmentally friendly fertilizers. Phosphite (Phi), a reduced form of P, was proposed after the Second World War as a promising alternative fertilizer due to its distinct chemical and biochemical properties compared to Pi [6, 15], These properties include higher solubility, lower reactivity with soil components, and the inability of most microorganisms to use Phi as a P source, thus increasing P availability for cultivated plants [15-17]. However, several reports have demonstrated that plants cannot metabolize Phi [7, 18-23] and that Phi compounds have phytotoxic effects that impair plant development, suggesting the possible use of Phi as a broad-spectrum non-selective herbicide. These data challenge the use of Phi as a direct source of P to support plant growth, and suggest that its known beneficial effects on plants are due to its well-documented properties for combating oomycetes and its capacity to activate plant defense mechanisms [21, 24, 25].

### C. RESULTS AND DISCUSSION

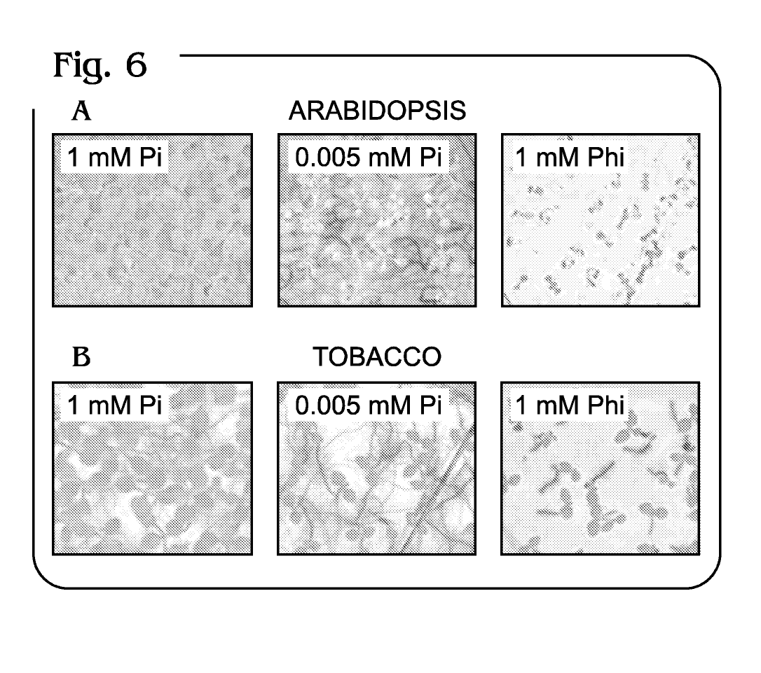

Some bacterial species capable of oxidizing Phi into Pi have been described previously [17]. In Pseudomonas stutzeri WM88, the ptxD gene encodes a highly Phi-specific oxidoreductase that oxidizes Phi using NAD⁺ as a cofactor, yielding Pi and NADH as products [8, 26]. To test whether a pathway to convert Phi into Pi could be engineered into plants, enabling them to use Phi as a P source and as a herbicide detoxification mechanism, we produced transgenic Arabidopsis lines expressing the ptxD coding sequence (“ptxDAt” lines) under the control of the constitutive 35S promoter (35S::PTXD) (see FIGS. 4 and 5).

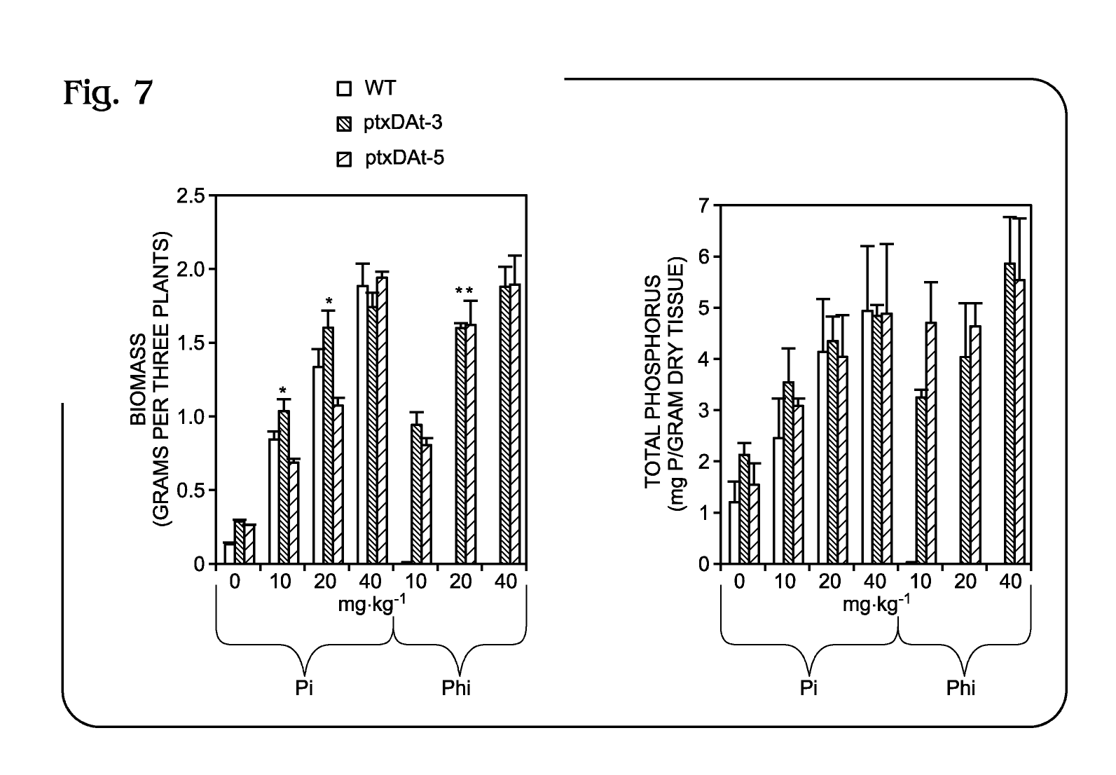

To confirm that 35S::PTXD plants are capable of using Phi as a P source, seeds from transgenic lines and non-transformed siblings were germinated in media lacking Pi, and supplemented with Phi. As previously reported [7, 18-23], control seedlings are unable to metabolize Phi, displaying restricted development and achieving a maximum size of 3 to 6 mm in length before their growth is completely arrested. In contrast, transgenic seedlings harboring the 35S::PTXD construct sustained similar growth as that observed for transgenic and control plants grown in media containing Pi (see FIGS. 5A and 6). ptxDAt lines cultivated in vertically oriented agar plates displayed vigorous growth with well-developed root systems, whereas control seedlings were arrested at the cotyledonary stage, developing short primary roots with little or no lateral root formation (see FIGS. 5B and 6).

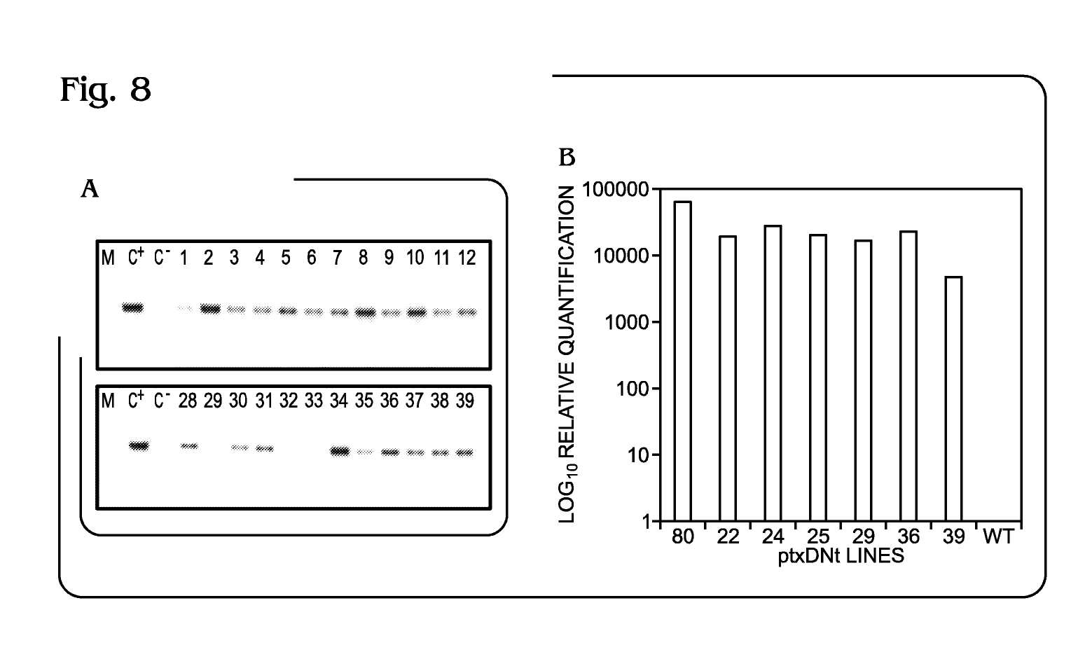

To determine whether PTXD Arabidopsis plants could efficiently use Phi as a P source when grown under greenhouse conditions, ptxDAt and control seedlings were transferred to pots containing a sterilized mixture of sand and vermiculite supplemented with Pi or Phi as P sources. ptxDAt lines fertilized with Phi clearly showed vigorous growth, whereas control plants under Phi treatments displayed more restricted growth than those grown in unfertilized substrate and survived for a maximum of 20 days (see FIG. 5C), confirming that Phi has a phytotoxic effect when the availability of Pi is low [22, 23]. ptxDAt lines under Phi fertilization produced biomass and accumulated P at levels indistinguishable from those of control and transgenic plants grown with Pi (see FIG. 7).

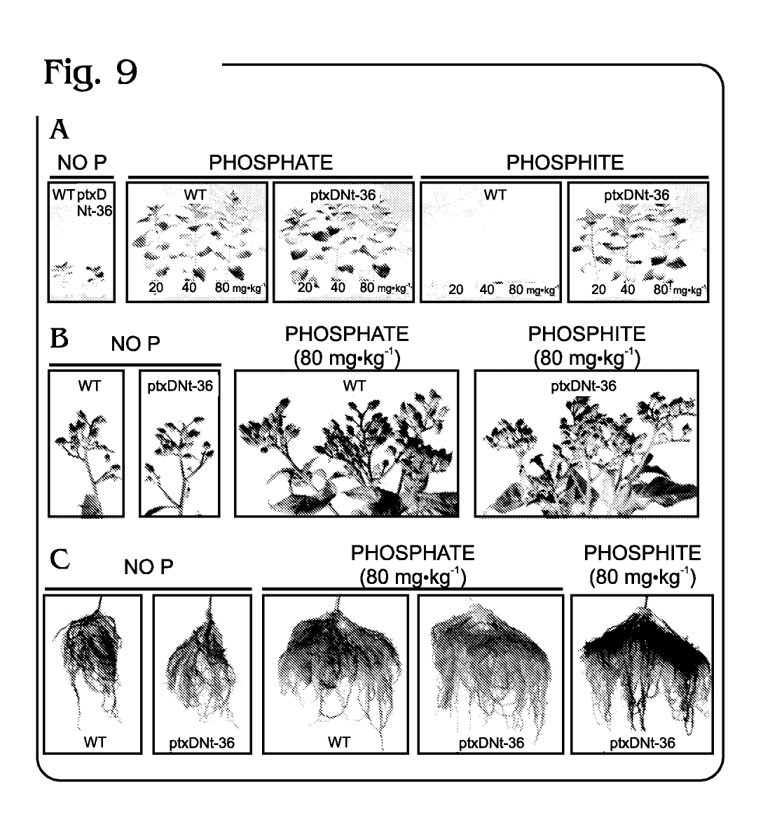

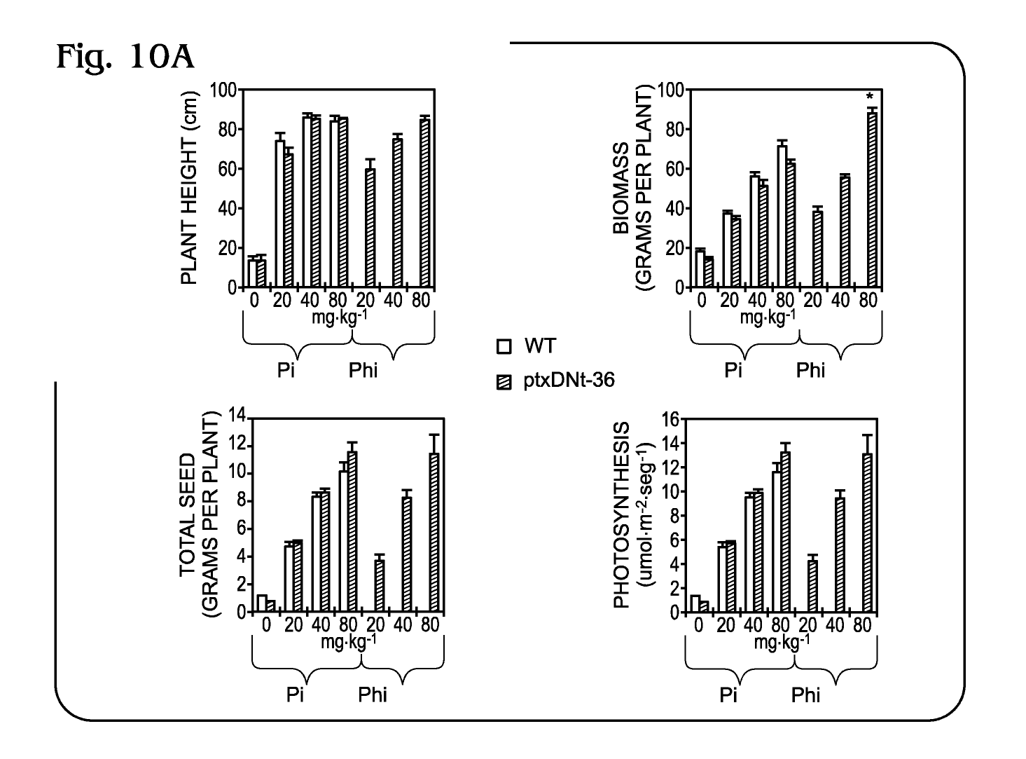

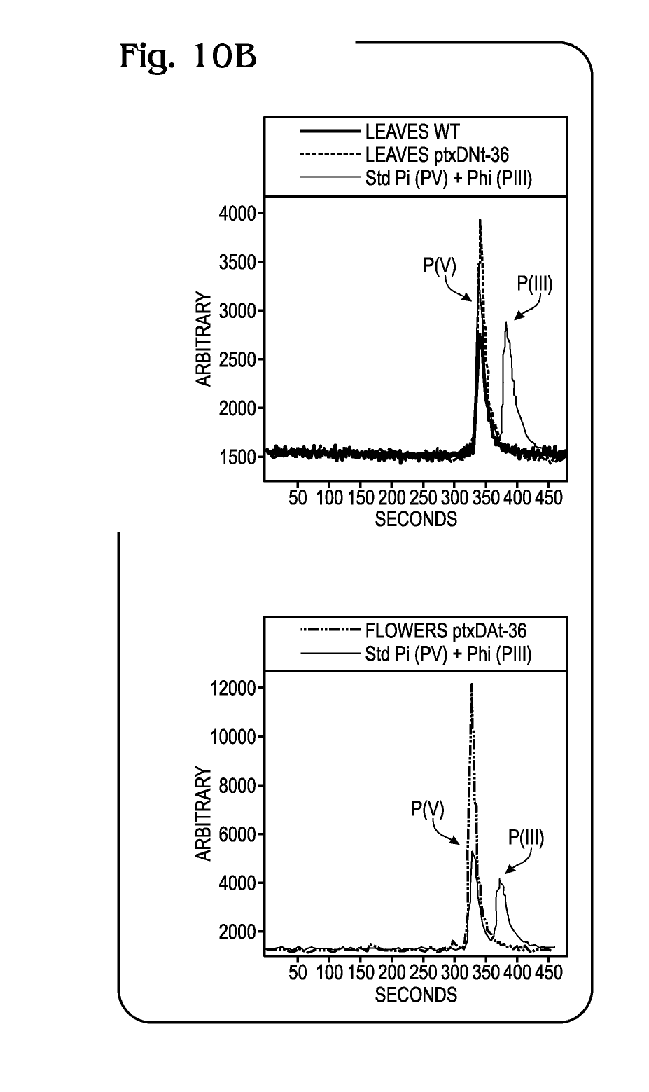

To determine whether expression of the ptxD gene would enable other plant species more amenable for physiological and weed-control studies to use Phi as a P source, we generated transgenic tobacco plants harboring the 35S::PTXD construct (ptxDNt lines) (see FIG. 8). Transgenic and control seedlings were transferred to plastic bags containing a sterilized mixture of sand and vermiculite amended with either Phi or Pi as P source. In the unfertilized substrate, both WT and transgenic plants showed significantly poorer growth than plants fertilized with Pi (see FIG. 9). In the substrate supplemented with Phi, WT plants completely arrested their development and died a few days after transplantation, whereas ptxDNt plants sustained normal growth and showed a similar phenotype to plants treated with Pi (see FIGS. 9-11). Because the main negative effect in vitro of Phi on WT plants was on root growth, we also examined the root system of transgenic and control plants grown under different treatments. Transgenic plants fertilized with either Phi or Pi displayed well-developed root systems, indicating that in both cases, they had enough Pi to fully support their development (see FIG. 9C). Transgenic plants fertilized with Phi quantitatively performed as well as WT and ptxDNt plants fertilized with Pi (see FIG. 10A). Total biomass produced by ptxDNt plants grown with 20 and 40 mg·kg⁻¹ of Phi was slightly higher than plants grown under similar Pi regimes (see FIG. 10A). Interestingly, this difference was greater (40%) and statistically significant when plants were fertilized with 80 mg·kg⁻¹ of Phi (see FIG. 10A). These results could reflect a higher availability of Phi than Pi for plant uptake under the experimental conditions used for these experiments.

Pi is essential for CO₂ fixation in the chloroplast, and plants suffering from Pi starvation have reduced levels of photosynthesis [27]. To determine whether Phi fertilization had a negative effect on photosynthesis of ptxDNt lines, we measured the rate of photosynthesis in transgenic and control plants under different treatments. When fertilized with either Pi or Phi, ptxDNt plants had rates of photosynthesis similar to those observed for control plants grown in Pi (see FIG. 10A). The effect on photosynthesis and root system development of control plants fertilized with Phi could not be evaluated because these plants died soon after transplantation.

Although no toxic effects on the growth of PTXD plants fertilized with Phi was observed, it was important to determine whether Phi is fully oxidized into Pi in these plants. We quantified Phi and Pi in leaves, flowers, and fruits. In all tissues analyzed from ptxDNt plants, the level of Phi was below detection levels and only Pi could be detected, suggesting that most, if not all Phi had become oxidized to Pi at the time of measurement (see FIG. 10B). Therefore, no residual Phi would be present in the plant organs used for food and feed production.

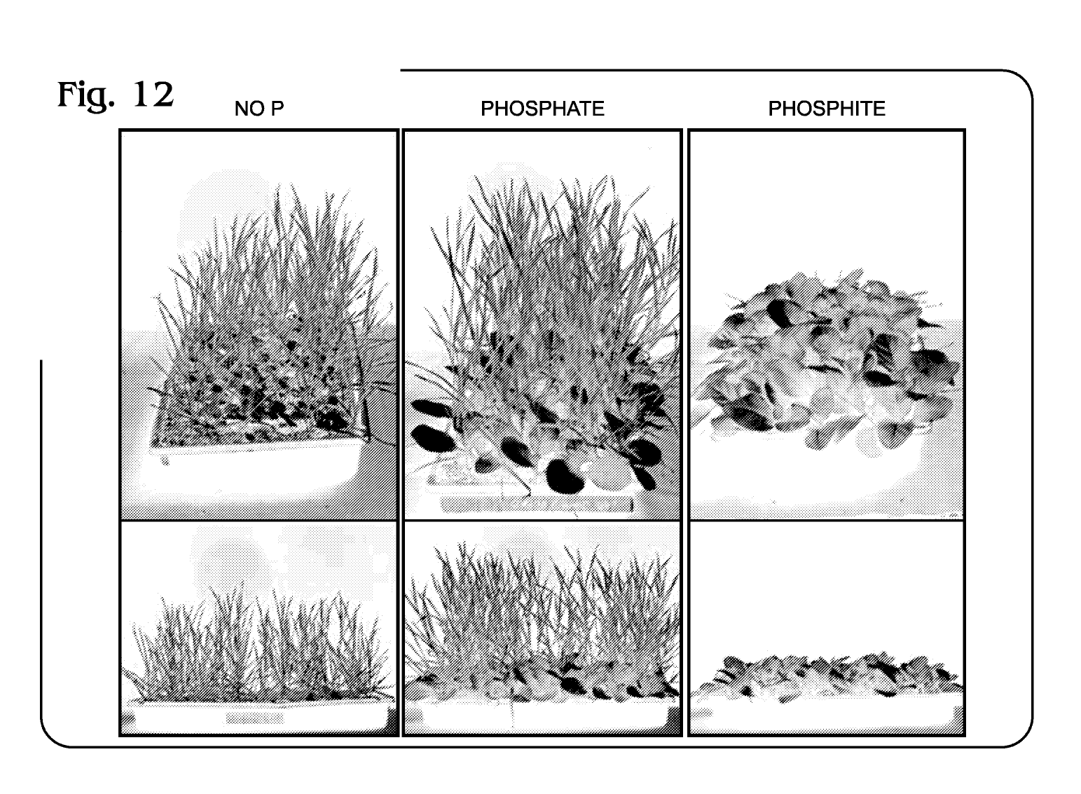

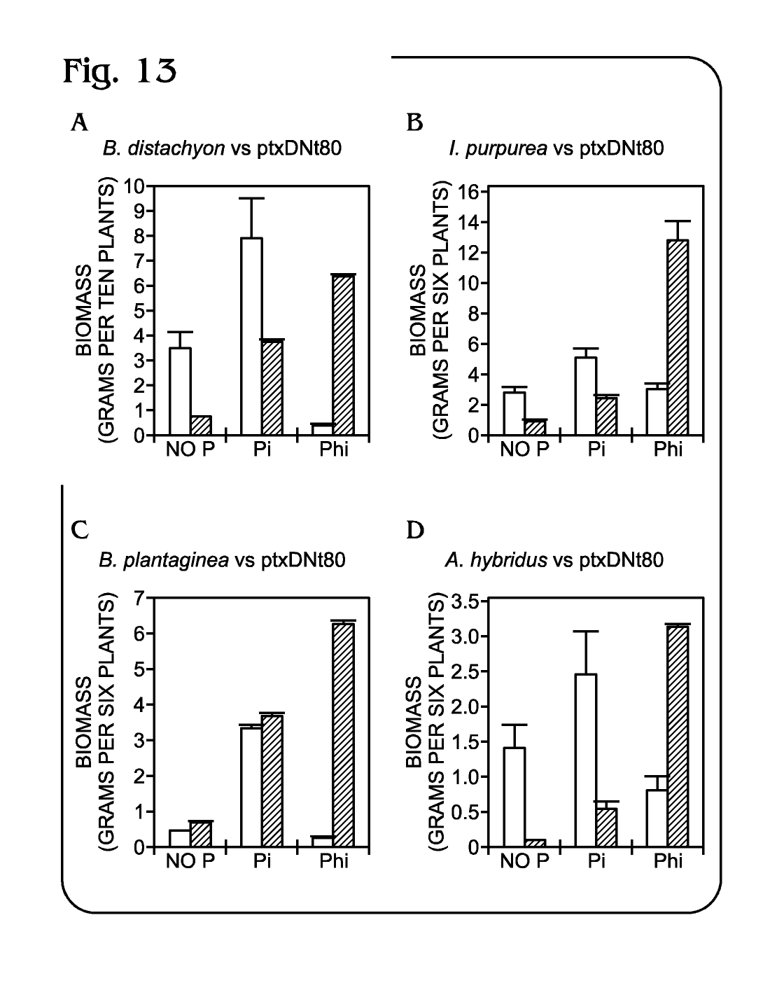

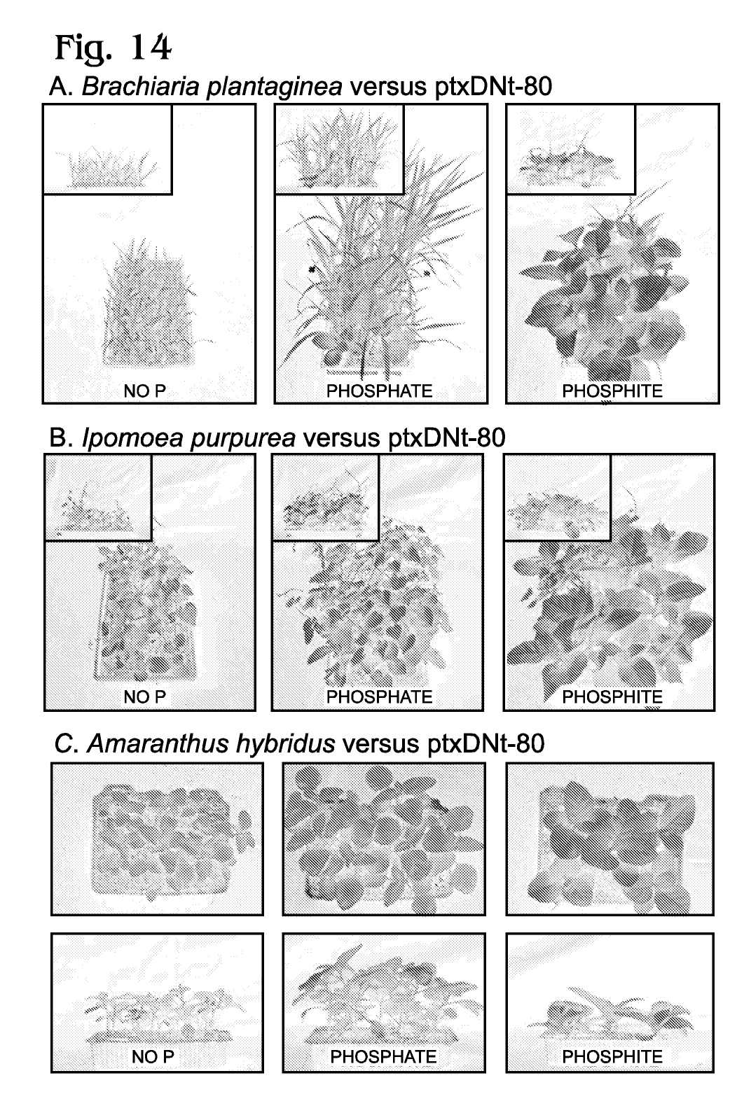

In addition to the incapacity of plants to metabolize it, Phi acts as a potentially effective herbicide mainly by interfering with the signaling pathways that induce the rescue system activated in Pi-starved plants [22, 23]. Cultivation of transgenic plants expressing the ptxD gene, combined with Phi as a P fertilizer, could be an effective weed control system in soils with low Pi availability. To test this idea, we carried out growth competition experiments between ptxDNt plants and the grass weed False Brome (Brachypodium distachyon), using Phi or Pi as a P fertilizer. In unfertilized soil, both B. distachyon and tobacco plants had limited growth. When soil was fertilized with Pi, the growth of both species increased, with the grass showing faster growth than the tobacco plants. When Phi was used as a fertilizer, the grass initially showed limited growth, which was completely arrested after 15-20 days after sowing, whereas ptxDNt plants sustained rapid growth similar to that observed in Pi fertilization, and after 15 days these plants rapidly outgrew the weed (see FIG. 12). Comparison of biomass produced under the different treatments showed that under Phi fertilization the biomass of the tobacco plants increased 865%, whereas that of the weed decreased 90% with respect to that observed using Pi fertilization (see FIG. 13). Importantly, similar results were obtained for three other agronomically important weeds, namely tall morning-glory (Ipomoea purpurea), alexander grass (Brachiaria plantaginea) and smooth pigweed (Amaranthus hybridus) (see FIGS. 13 and 14), for which resistance to other herbicides has already been reported [2, 5].

The transgenic system reported here exploits the chemical and biological properties of Phi, providing definite advantages over current Pi fertilizer systems. The results strongly suggest that a lower total amount of P should be needed to achieve optimal plant productivity using Phi rather than Pi as fertilizer. Because of its effectiveness in weed control and fertilization, this system should reduce production costs and energy consumption by replacing the independent application of fertilizer and herbicides with a single treatment and also by eliminating the cost of additional herbicides. Since Phi is efficiently transported through the plant's vascular tissues [28], it acts as a systemic herbicide that could be applied as both pre- and post-emergent. Moreover, because the phytotoxic effect of Phi is produced by attenuating a broad spectrum of Pi-starvation induced plant responses and by potentially acting as a competitive inhibitor of enzymatic reactions that use Pi as substrate [18-24], it is less likely that weeds would evolve resistance to Phi than to currently used herbicides with single target enzymes [5].

While the transgenic system could bring obvious benefits to producers, it is important to assess any potential hazards due to genetic modification. Phi is already extensively used in agriculture in several countries and, in 1997, was approved by the U.S. Environmental Protection Agency for use as fungicide in many food and non-food crops because it is innocuous to humans and animals. Phi has also been approved as an organic fertilizer. Moreover, the products of the reaction, Pi and NADH, are also innocuous and present in all living cells. Additionally, since Phi is not naturally present in soil, the potential escape of PTXD-encoding transgenes into wild species should have no effect on genetic diversity or survival outside agricultural systems. Another potential advantage of the Phi/PTXD fertilization scheme is that since green algae are unable to metabolize Phi [29], its use should decrease the environmental impact of current Pi-based fertilization systems, which cause eutrophication of aquatic ecosystems by promoting massive algal growth that in turn leads to oxygen depletion in rivers, lakes and oceans, causing the death of other organisms such as fish [13]. The approach disclosed herein is also technically applicable as a general selectable marker for plant transformation and for the genetic modification of microalgae to be used for biomass or biofuel production in open, naturally-illuminated reactors, significantly reducing the risks of contamination and avoiding the use of costly closed and artificially-illuminated chambers [30].

### D. METHODS

Overview.

The 35S::ptxD construct was generated by Gateway® Technology using the ptxD coding sequence from Pseudomonas stutzeri WM88 and the destination vector pB7WG2D. To transform Arabidopsis and tobacco plants, a modified floral dip protocol and basic steps of the leaf-disk method, respectively, were followed. Transgenic lines were selected using phosphinotricin as selective agent and corroborated by PCR, Southern Blot hybridizations, or qRT-PCR analysis. For phosphite and orthophosphate determination, 40 to 50 mg samples were extracted in 10 mM EDTA at pH 8.0 and analyzed using an Agilent 7500ce ICP-MS equipment. Total P content was determined using the vanadate-molybdate colorimetric method.

General Reagents.

All reagents utilized in the experiments were from Sigma Aldrich, unless otherwise stated. For all experiments using solid tissue culture media, the agar used was Plant TC from Phytotechnology Laboratories.

Design of 35S::ptxD.

To obtain transgenic plants expressing the ptxD coding sequence from Pseudomonas stutzeri WM88, the complete ORF of this gene was amplified from pWM302 plasmid (kind gift of Dr. William W. Metcalf [8]), and placed under the control of the CaMV35S promoter in the binary vector pB7WG2D (Gateway® Technology). PCR amplification was performed using Taq DNA polymerase (Invitrogen) (3 min 94° C., 1 min 94° C., 50 seg 59° C., 1 min 72° C., 7 min 72° C., a 4° C.) and the following primers that were designed with attB sites to be used with Gateway Technology:

(SEQ ID NO: 21)
PTXDFWB1 - (5′-GGGGA CAAGT TTGTA CAAAA AAGCA
GGCTA AATGCT GCCGA AACTC GTTAT AACTC-3′);
and
(SEQ ID NO: 22)
PTXDRVB2 - (5′-GGGGA CCACT TTGTA CAAGA AAGCT
GGGTA TCAAC ATGCG GCAGG CTC-3′).

Amplified PCR fragments were electrophorated on a 1% agarose/TAE gel and purified using GFX™ PCR DNA and the Gel Band Purification kit (Illustra™ GE HEALTHCARE) following the manufacturer's instructions. The resulting ptxD amplification fragment was cloned into pGEM-T Easy vector (Promega), and then subjected to two sequential site-specific recombination reactions, using the pDONR 221 donor and pB7WG2D destination vectors according the manufacturer's instructions. All vectors were subjected to restriction analysis and DNA sequencing to confirm the presence of the expected sequences.

Generation and Selection of Transgenic Plants.

pB7WG2D::ptxD was introduced into Agrobacterium tumefaciens strain GV2260 and used to produce ptxDAt lines following a modified floral dip transformation protocol [31]. To select transgenic plants, seeds were sown on growth medium (MS salts, 5 g·L⁻¹ sucrose, 10 g·L⁻¹ agar, pH 5.7) supplemented with 20 mg·L⁻¹ phosphinothricin. Thirty independent Arabidopsis lines were transferred to soil (perlite: vermiculite: Canadian peat moss; 1:1:1) and self-pollinated. T2 lines with a 3:1 segregation (χ² test, P<0.05) for phosphinotricin resistance were selected and homozygous T3 seed stocks obtained. Fifteen transgenic lines were assayed for their capacity to utilize Phi as a unique P source; all were found to have this capacity. The presence and expression of the 35S::PTXD construct were analyzed in seven of these lines by Southern Blot hybridizations [32] and qRT-PCR analyses [33], respectively. Two homozygous lines with high-expression levels (ptxDAt-3 and -4) and two with low-expression levels (ptxDAt-5 and -7) were selected for further characterization.

To transform Nicotiana tabacum L. cv Xanthi, the leaf-disk method [34] was used. After co-cultivation, explants were transferred to selection medium (MS salts, 30 g·L⁻¹ sucrose, 1 g·L⁻¹ N6-benzyladenine, 2.5 g·L⁻¹ gelrite, pH 5.7) supplemented with 5 mg·L⁻¹ phosphinotricin and sub-cultured in fresh medium every 2-3 weeks. Regenerated shoots were cultured on selective medium supplemented with 10 mg·L⁻¹ of indoleacetic acid to induce root formation. Growth of eight lines randomly selected lines in Phi-containing media confirmed that all were capable of using Phi as a P source. The presence and expression of the 35S::PTXD construct were confirmed in eighty and seven randomly selected lines by genomic PCR and qRT-PCR [33], respectively.

PCR and Southern Blot Analysis.

Genomic DNA was extracted from complete plantlets using the CTAB method (cetyl trimethyl ammonium bromide) and cleaned using Durapore membranes (MSGVN2250, Millipore) according to the manufacturer's instructions. For genomic PCR analysis, 200 ng of total genomic DNA were used to amplify the complete pxtD coding region using standard amplification conditions (3 min 94° C., 1 min 94° C., 50 seg 59° C., 30 seg 72° C., 7 min 72° C., a 4° C.) and the following primers:

(SEQ ID NO: 23)
PTXDFW (5′-ATGCT GCCGA AACTC GTTAT AACTC-3′)
and
(SEQ ID NO: 24)
PTXDRV (5′-TCAAC ATGCG GCAGG CTC-3′).

PCR Products were electrophorated in 1% agarose/TAE gels and observed under UV light. For Southern blot hybridization analysis [32] 15 μg of total DNA were digested with EcoRI and EcoRV restriction enzymes (Invitrogen), separated on a 1% agarose/TAE gel and capillary-blotted onto Hybond-N⁺ nylon membrane (Amersham Pharmacia Biotech). The nucleic acids were fixed covalently to membranes using a UV crosslinker. A probe corresponding to the first 400 bp of the ptxD gene, starting from the ATG and generated by PCR using the PTXDRT primers (3 min 94° C., 1 min 94° C., 50 seg at 59° C., 30 seg at 72° C., 7 min 72° C., a 4° C.), was used for hybridization experiments. The PTXDRT primers are as follows: PTXDRTFW (5′-ATGCT GCCGA AACTC GTTAT AACTC-3′) (SEQ ID NO:25) and PTXDRTRV (5′-CTGCA AGCGA TCAGC CATG-3′) (SEQ ID NO:26).

The probe was purified on a 1% agarose/TAE gel and processed using the GENECLEAN® kit (MPBIO) and radiolabeled with ³²P using the Random Primers DNA Labeling System (Invitrogen) according to the manufacturer's specifications. Membranes were blocked using a 5×Denhardt's based solution and hybridized with the ptxD probe and washed according to standard protocols. Membranes were visualized by phosphor imaging on a Storm 840 Phosphor Imaging System (Molecular Dynamics, Sunnyvale, Calif., USA).

Real Time-PCR.

Total RNA was isolated using Trizol reagent (Invitrogen, Carlsbad, Calif.) and Qiagen RNA easy columns (Invitrogen). Real-time PCR of the ptxD gene (PTXDRT primers) was performed in an ABI PRISM 7500 real time thermocycler (Applied Biosystems) and reactions for Arabidopsis Actin 2 and Tobacco ActinNt were utilized for normalization.

Relative quantification (RQ) number for each independent transgenic line was obtained from the equation 2̂^{ΔΔCτ}, where ΔΔCτ represents the subtraction of the CT value of the internal control from the CT value of the ptxD gene (PTXDRT primers) (ΔCT(PTXD)−ΔCT(ACTIN). ΔCT was calculated using the equation [CT(ptxD)*E]−[CT(ACTIN)*E], and E is the PCR efficiency ([10^{(-1/m)}]−1) [33]. Expression levels were obtained from at least three replicates.

Greenhouse Experiments.

For Arabidopsis greenhouse experiments, pots were filled with 0.3 kg of a sterilized mixture of sand and vermiculite (1:1) and mechanically mixed with either Pi (KH₂PO₄) or Phi (NaH₂PO₃.5H₂O) at 10, 20, and 40 mg·kg⁻¹. For tobacco experiments, 3 kg of the same substrate were weighed in black plastic bags amended with 20, 40, and 80 mg·kg⁻¹ of Pi or Phi. One plant per pot and 8-10 plants per line per treatment were included. Pots were arranged following a completely random design in the greenhouse. At harvest, aerial parts of Arabidopsis (36 days old) and Tobacco (120 days old) plants were cut off at the soil surface and dried in a vacuum oven at 70° C. for biomass quantification. In all cases, seeds were collected separately. Photosynthesis rate was determined using a portable Li-6200 photosynthesis system (Li-Cor, Lincoln, Nebr., USA) on fully expanded, young leaves. Leaf area was calculated using the software ImageJ [35].

For growth competition experiments, different proportions of seeds from ptxDNt-80 and the following weeds were utilized (transgenic:weed): Ipomoea purpurea (13:30), Brachiaria plantaginea (13:60), Amaranthus hybridus (5:15), Brachypodium distachyon (50:50). All seeds were sown in a tray containing a nonsterilized mixture of sand and vermiculite (2 kg for experiments with Amaranthus hybridus and 6 kg for the rest). The source of P was provided through either irrigation with a solution or amendment in the soil with 50 or 60 mg·kg⁻¹ of Pi or Phi, as indicated in each experiment. Plants were harvested (at 54 day old for Brachiaria and Ipomoea or at 40 day old for A. hybridus experiments) for biomass quantification. All parameters were subjected to statistical analysis using ANOVA and Tukey tests (P<0.05).

After 4 months under treatment in greenhouse conditions, tissues from tobacco plants were collected, washed with de-ionized water to remove any surface contaminant, and frozen in liquid nitrogen. Homogenized tissue samples were lyophilized. Sample (40-50 mg) was extracted during 20 min in an ultrasonic bath with 0.5 mL of a 10 mM EDTA solution, pH 8.0. After centrifugation (10000×g, 10 min), the supernatant was cleaned-up (Supelclean LC-18 SPE tubes 3 ml, Supelco) and filtered (IC Acrodisc filter, 0.2 μm, Sigma-Aldrich).

An Agilent series 1050 liquid chromatographic system equipped with a quaternary pump, a column oven, and ChemStation (Agilent Technologies, Palo Alto, Calif., USA) was used. The chromatographic column was Luna SAX (250×4.6 mm, 5 μm) from Phenomenex. For specific detection of P, the column effluent was on-line introduced to an inductively-coupled plasma mass spectrometry system via a short length of Teflon tubing.

A model 7500ce ICP-MS (Agilent Technologies, Tokyo, Japan) was used with a MiraMist Teflon® nebulizer. A Peltier-cooled chamber was operated at 2° C. A tuning procedure was performed daily using diluted Agilent solution (Li, Y, Tl, Ce, 1 μg·L⁻¹ each). The chromatographic and ICP-MS instrumental operating conditions are given in Table 1. In order to control polyatomic interferences from ¹⁵N¹⁶O⁺, ¹⁴N¹⁶O¹H⁺ and ¹²C¹H₃¹⁶O⁺ ions potentially occurring at m/z=31, the octopole reaction/collision cell was used in kinetic energy discrimination mode. The selection criterion for gas flow rate was the highest possible signal to noise ratio, as described elsewhere [36].

TABLE 1
HPLC-ICP-MS instrument operating conditions

| | |
|---|---|
| Column | Luna SAX18 (250 × 4.6 mm, 5 μm) |
| | with a guard column |
| Mobile phase | 10 mM potassium phthalate, |
| | pH 4.0 |
| Elution | Isocratic |
| Temperature | Ambient |
| Flow | 1.2 mL · min⁻¹ |
| Injection volume | 50 μL |
| ICP-MS detection | |
| Forward power | 1500 W |
| Nebulizer gas flow | 0.9 L · min⁻¹ |
| Make-up gas | 0.1 L · min⁻¹ |
| Nebulizer | MiraMist Teflon ® |
| Spray chamber | |
| Peltier-cooled chamber | 2° C. |
| Sample and skimmer | Platinum |
| cones | |
| Sample depth | 8 mm |
| Channel monitored | ³¹P |
| Acquisition mode | Time-resolved analysis |
| Dwell time | 100 ms |
| Collision/reaction cell | 3.5 mL · min⁻¹ He |

Reagents blanks and commercial standards of two P species were used for external calibration (between 0.2-2.5 nmoles of Pi and Phi on column). The recovery of the procedure, evaluated by standard addition experiments, was 94.2% and 98.6% for Pi and Phi, respectively. Total P content was determined using the vanadate-molybdate colorimetric method [37].

### E. FIGURE LEGENDS

FIG. 4. Stable insertion and expression of the ptxD gene in Arabidopsis transgenic lines. (A) Confirmation of the presence of the ptxD gene in transgenic Arabidopsis lines by Southern blot hybridization using a ptxD-specific probe. DNA was digested with EcoRV that liberates a fragment containing a region of the ptxD gene, and with EcoRI for which the T-DNA has a single restriction site. (B) qRT-PCR determination of the relative ptxD mRNA levels in different transgenic Arabidopsis lines harboring the 35S::PTXD construct (relative to the expression level of actin).

FIG. 5. Transgenic Arabidopsis plants expressing a phosphite oxidoreductase can use phosphite as a phosphorus source. (A) Comparative growth of seedlings from ptxDAt-3, -5 and -7 lines, and wild type (WT, Col-0) in solid media containing 1 mM phosphate (Pi) or 1 mM phosphite (Phi). (B) Transgenic Arabidopsis lines and WT control grown in vertical plates containing 1 mM Phi. (C) Transgenic and WT plants grown in a sterilized mixture of sand and vermiculite fertilized with Pi or Phi as phosphorus (P) source. Treatment without addition of a P source (NO P) was utilized as a control. A top view of WT plants in media containing 40 mg·kg⁻¹ Phi is included. Photographed plants are representative of two experiments with 8-10 plants/treatment/line each. Concentrations of Pi, Phi, and the identity of the transgenic lines and controls are indicated in the figure. The bar represents 5 cm to indicate scale.

FIG. 6. Growth of WT Arabidopsis and tobacco plants in phosphite-containing media. Comparative growth of Arabidopsis and tobacco non-transformed seedlings in media lacking a phosphorus (P) source supplemented with 1 mM or 0.005 mM phosphate (Pi) or 1 mM phosphite (Phi). The Arabidopsis and tobacco seedlings, in Phi-containing media, arrested their growth at the cotyledonary stage and displayed a root system (shorter primary root with a reduced lateral root emergence) significantly smaller than those grown in media lacking a P source.

FIG. 7. Biomass production and phosphorus content of transgenic and control plants in a solid substrate. Quantification of total biomass and total phosphorus (P) content in control WT, ptxDAt-3, and ptxDAt-5 plants grown on a sterilized mixture of sand and vermiculite amended with increasing concentrations of P applied as phosphate (Pi) or phosphite (Phi). The data for biomass represent the average and standard error of 3-5 replicates with 3 plants each. In the case of P determinations, the data represent the average and standard error of 3-5 plants with 3 replicates each. * indicate measurements that are statistically different from the corresponding control (p<0.005).

FIG. 8. Detection and expression of the ptxD gene in transgenic tobacco lines. (A) Confirmation of the presence of the ptxD gene in transgenic tobacco lines by PCR to amplify the open reading frame of the gene (1011 bp). (B) qRT-PCR determination of the relative ptxD mRNA levels in different transgenic tobacco lines harboring the 35S::PTXD construct (relative to the expression level of actin). M: nucleic acid marker (1 kb ladder).

FIG. 9. Use of phosphite as a sole source of phosphorus by transgenic tobacco plants. Comparison of the general growth (A), capsule production (B), and root system development (C) between ptxDNt-36 and wild-type plants (WT) using phosphate (Pi) or phosphite (Phi) as a sole phosphorus (P) source on a mixture of sterilized sand and vermiculite (65 days old). Treatment without addition of a P source (NO P) was utilized as a control. Photographed plants are representative of two experiments with 8-10 plants/treatment/line each. Pictures were taken using the same magnification for each panel.

FIG. 10. Productivity, photosynthesis, and phosphite content of transgenic tobacco plants fertilized with phosphite. (A) Comparison of plant height, biomass, yield of seeds, and photosynthesis between ptxDNt-36 and control (WT) plants growing on sterilized sand and vermiculite mixture amended with increasing concentrations (mg·kg⁻¹) of phosphorus (P) supplemented as phosphate (Pi) or phosphite (Phi); treatment without addition of a P source (NO P) was utilized as a control. The data represent the average and standard error of two experiments with 8-10 plants/treatment/line each. (B) Analysis using an HPLC-ICP-MS based protocol to assay the Pi and Phi content of ptxDNt-36 plants grown in a Phi-amended substrate and WT plants grown in a Pi-amended substrate. The Pi (P V) and Phi (P III) standards are indicated. The Pi content in wild-type plants grown in a Pi-fertilized substrate, and the Pi and Phi content of ptxDNt-36 plants grown in a substrate fertilized with Phi are shown. Note that Phi was not detected either in leaf or floral tissues of ptxDNt-36 plants grown in a Phi-amended substrate. * Indicates measurements that are statistically different from the corresponding control (p<0.005).

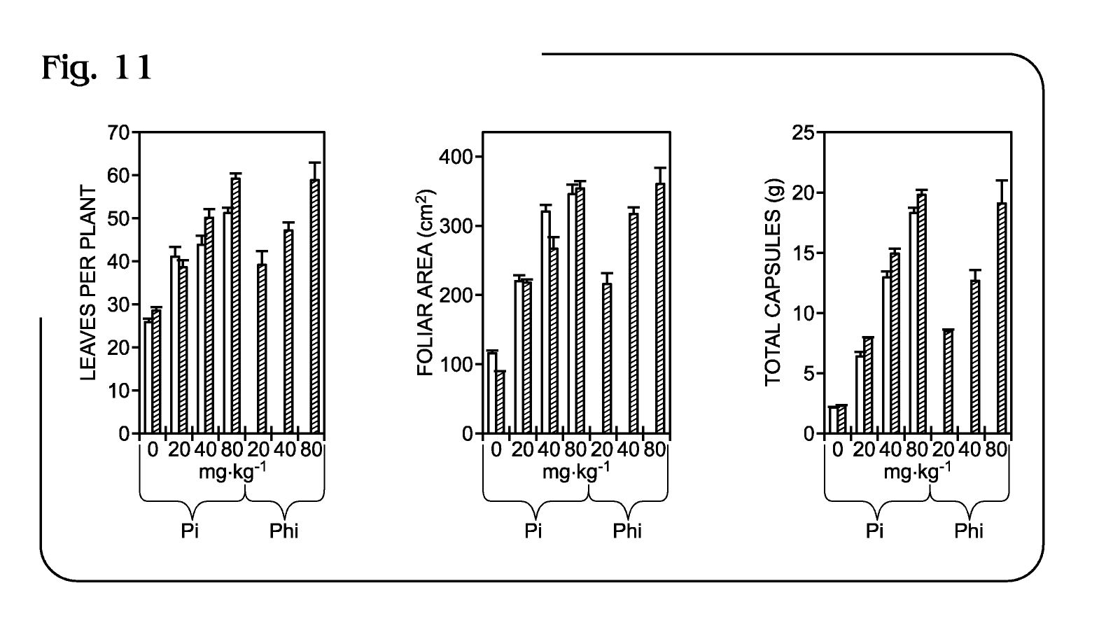

FIG. 11. Effect of phosphorus availability on the development of transgenic and control plants. Determination of leaf number, foliar area, and capsule production in ptxDNt-36 plants (hatched bars) and WT plants (open bars) using phosphate (Pi) or phosphite (Phi) as the P source. Similar responses were obtained for Pi- and Phi-based treatments of the transgenic plants. The data represent the average and standard error of two experiments with 8-10 plants/treatment/line each. * indicates measurements that are statistically different from the corresponding control (p<0.005).

FIG. 12. A dual fertilization and weed-control system using PTXD plants. The photographs show growth competition between the ptxDNt-80 transgenic tobacco line and Brachypodium distachyon (grass) plants in a non-sterilized sand and vermiculite mixture irrigated with a nutrient solution containing 1 mM phosphate or phosphite as phosphorus (P) source. Photographed plants (34 days after germination), taken from two views for each condition, are representative of two experiments with two replicates per treatment. NO P indicates a treatment without addition of fertilizer.

FIG. 13. Biomass production in competition experiments between transgenic tobacco plants and different weeds. Biomass determination of ptxDNt-80 plants (hatched bars) and weed plants (open bars) after growth competition assays in a non-sterilized sand and vermiculite mixture irrigated with a nutrient solution containing phosphate (Pi) or phosphite (Phi) as the phosphorus (P) source. Treatment without P fertilization (NO P) was utilized as a control. Note the significant reduction of the weed biomass and the increase in tobacco biomass when Phi is used as a fertilizer. The data represent the average and standard error of two experiments with 2 replicates per treatment each.

FIG. 14. Effectiveness of phosphite fertilization to control different weed species. The photographs show exemplary results of competition experiments between ptxDNt-80 transgenic plants and three different weed species grown in a non-sterilized sand and vermiculite mixture amended with phosphate (Pi) or phosphite (Phi) as a phosphorus source (P), or irrigated with a nutrient solution lacking P. Pictures were taken at 54 days (panels A and B) and 40 days (panel C) after seed germination. Note that in the Pi treatment for Amaranthus and tobacco competition, only Amaranthus plants can be observed in the top view picture, whereas in the Phi treatment only the tobacco plants are observed. Photographed plants are representative of two experiments with two replicates per treatment each.

### F. ACCESSION NUMBERS

Sequence data can be found in the GenBank database under the following accession numbers: ACT2 (At3g18780), ACTINNT (GQ339768), and PTXD (AF061070).

### G. REFERENCES

The following references are cited above by numbers enclosed in brackets.
1. Tilman, D. et al. Agricultural sustainability and intensive production practices. Nature 418, 671-677 (2002).
2. Gianessi, L. P & Reigner, N. P. The Value of Herbicides in U.S. Crop Production. Weed Technol. 21, 559-566 (2007).
3. Dawson, C. J. & Hilton, J. Fertiliser availability in a resource-limited world: Production and recycling of nitrogen and phosphorus. Food Policy 36, S14-S22 (2011).
4. Cordell, D., Drangert, J-O & White, S. The story of phosphorus: Global food security and food for thought. Global. Environ. Chang. 19, 292-305 (2009).
5. Powles, S. B. & Yu, Q. Evolution in Action: Plants Resistant to Herbicides. Annu. Rev. Plant. Biol. 61, 317-347 (2010).
6. Ruthbaum, H. P. & Baille, W. J. H. The use of red phosphorus as a fertilizer. part 4. phosphite and phosphate retention in soil. New Zealand J. Sci. 7, 446-451 (1964).
7. Schroetter, S., Angeles-Wedler, D., Kreuzig, R., Schnug, E. Effects of phosphite on phosphorus supply and growth of corn (Zea mays). Landbauforschung Völkenrode 56, 87-99 (2006).
8. Garcia-Costas, A. M., White, A. K. & Metcalf W. W. Purification and Characterization of a Novel Phosphorous-oxidizing Enzyme from Pseudomonas stutzeri WM88. J. Biol. Chem. 276, 17429-17436 (2001).
9. Gilbert, N. The disappearing nutrient. Nature 461, 716-718 (2009).
10. Cakmak, I. Plant nutrition research: priorities to meet human needs for food in sustainable ways. Plant Soil 247, 3-24 (2002).
11. Hinsinger, P. Bioavailability of soil inorganic P in the rhizosphere as affected by root-induced chemical changes: a review. Plant Soil 237, 173-195 (2001).
12. Syers, J. K., Johnston, A. E. & Curtis, D. Efficiency of soil and fertilizer phosphorus use: reconciling changing concepts of soil phosphorus behavior with agronomic information. FAO, Fertilizer and Plant Nutrition Bulletin 18 (2008).
13. Carpenter, S. R. Phosphorus control is critical to mitigating eutrophication. Proc. Natl. Acad. Sci. USA 105, 11039-11040 (2008).
14. Abelson, P. H. A Potential Phosphate Crisis. Science 283, 5410, 2015 (1999).
15. Morton, S. et al. Analysis of reduced phosphorus in samples of environmental interest. Environ. Sci. Technol. 39, 4369-4376 (2005).
16. Pasek, M. Rethinking early Earth phosphorus geochemistry. Proc. Natl. Acad. Sci. USA 105, 853-858 (2008).
17. White, A. K. & Metcalf, W. W. Microbial Metabolism of Reduced Phosphorus Compounds. Annu. Rev. Microbiol. 61, 379-400 (2007).
18. Ouimette, D. G. & Coffey, M. D. Phosphonate levels in Avocado (Persea amercana) seedlings and soil following treatment with Fosetyl-Al or potassium phosphonate. Plant. Dis. 73, 212-215 (1989).
19. Carswell C. et al. The Fungicide Phosphonate Disrupts the Phosphate-Starvation Response in Brassica nigra Seedlings. Plant. Physiol. 110, 105-110 (1996).
20. Carswell, M. C., Grant, B. R. & Plaxton, W. C. Disruption of the Phosphate-Starvation Response of Oilseed Rape Suspension Cells by the Fungicide Phosphonate. Planta 203, 67-74 (1997).
21. Förster H. et al. Effect of Phosphite on Tomato and Pepper Plants and on Susceptibility of Pepper to Phytophthora Root and Crown Rot in Hydroponic Culture. Plant. Dis. 82, 1165-1170 (1998).
22. Ticconi, C. A., Delatorre, C. A. & Abel, S. Attenuation of phosphate starvation responses by phosphite in Arabidopsis. Plant. Physiol. 127, 963-972 (2001).
23. Varadarajan, D. K. et al. Phosphite, an analogue of phosphate, suppresses the coordinated expression of genes under phosphate starvation. Plant. Physiol. 129, 1232-1240 (2002).
24. McDonald, A. E., Grant, B. R. & Plaxton, W. C. Phosphite (phosphorus acid): its relevance in the environment and agriculture and influence on plant phosphate starvation response. J. Plant. Nutr. 24, 1505-1519 (2001).
25. Saindrenan, P., Barchietto, T. & Gilbert, B. Modification of the phosphite induced resistance response in leaves of cowpea infected with Phytophthora cryptogea by α-aminooxyacetate. Plant. Sci. 58, 245-252 (1988).
26. Metcalf, W. W. & Wolfe, R. S. Molecular Genetic Analysis of Phosphite and Hypophosphite Oxidation by Pseudomonas stutzeri WM88. J. Bacteriol. 180, 5547-5558 (1998).
27. Rao, I. M., Arulanantham, A. R., & Terry, N. Leaf Phosphate Status, Photosynthesis and Carbon Partitioning in Sugar Beet. II. Diurnal Changes in Sugar Phosphates, Adenylates, and Nicotinamide Nucleotides. Plant. Physiol. 90, 820-826 (1989).
28. Ouimette, D. G. & Coffey, M. D. Symplastic entry and phloem translocation of phosphonate. Pestic. Biochem. Physiol. 38, 18-25 (1990).
29. Lee, T-M et al. The effects of phosphite on phosphate starvation responses of Ulva lactuca (Ulvales, Chlorophyta). J. Phycol. 41, 975-982 (2005).
30. Demirbas, A. Use of algae as biofuel sources. Energ. Convers. Manage. 51, 2738-2749 (2010).
31. Martinez-Trujillo, et al. Improving Transformation Efficiency of Arabidopsis thaliana by Modifying the Floral Dip Method. Plant. Mol. Biol. Reporter. 22, 63-70 (2004).
32. Sambrook, J. & Russell, D. W. Molecular cloning: a laboratory manual (Cold Spring Harbor Laboratory, 2001).
33. Livak, K. J. & Schmittgen, T. D. Analysis of Relative Gene Expression Data Using Real-Time Quantitative PCR and the 2[-Delta Delta C (T)] Method. Methods 25, 202-208 (2001).
34. Horsch, R. B. et al., Science 227, 1229 (1985).
35. Abramoff, M. D., Magelhaes, P. J. & Ram, S. J. Image Processing with ImageJ. Biophotonics International 11, 36-42 (2004).
36. Wrobel, K. et al. Phosphorus and osmium as elemental tags for the determination of global DNA methylation—a novel application of high performance liquid chromatography inductively coupled plasma mass spectrometry in epigenetic studies. J. Chromatogr. B. 878, 609-614 (2010).
37. Hesse, P. R. Soil phosphorus: its measurements and its uptake by plants. Aust. J. Soil. Res. 35, 227-239 (1971).

### Example 2

### Experimental Results for Transgenic Tobacco in Agricultural Soil

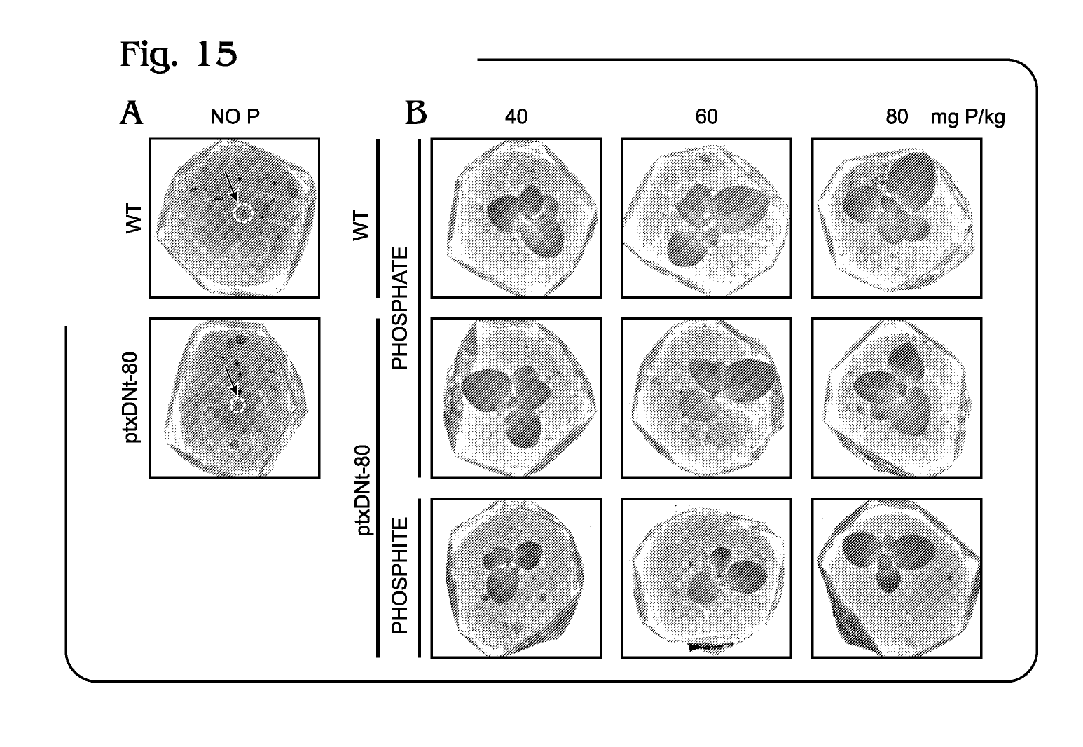

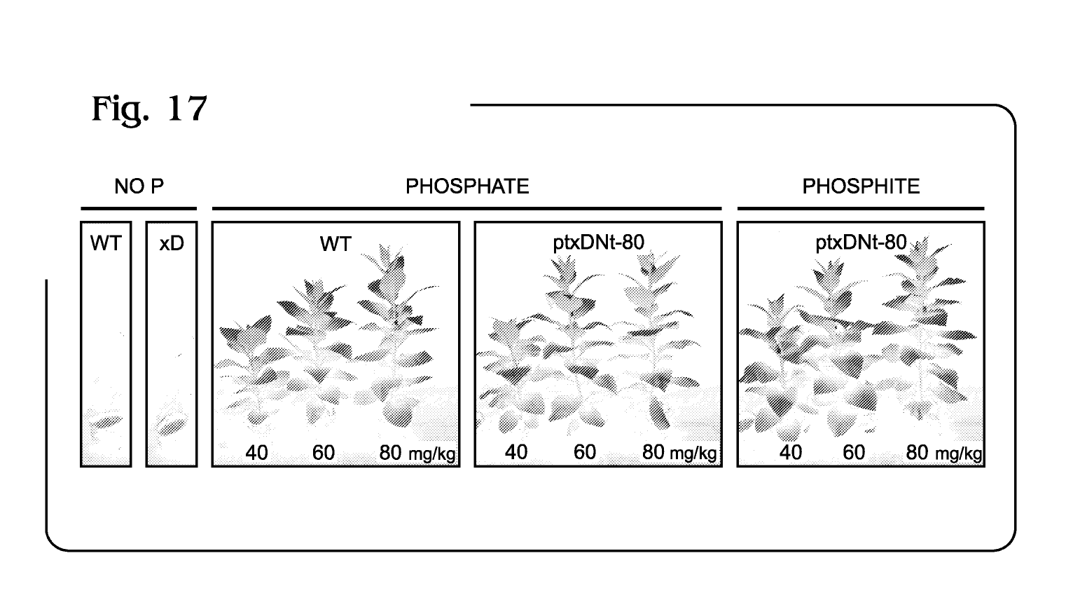

This example describes exemplary experimental results obtained with a transgenic line of tobacco modified genetically to oxidize phosphite to phosphate and thereby use the phosphite as a phosphorus source, and a control (wild-type) line of tobacco, each cultivated in agricultural soil having a low phosphorus content, with no added phosphorus or with addition of phosphate or phosphite; see FIGS. 15-20.

The results of Example 1 were obtained from greenhouse experiments with plants grown in a sterilized mixture of sand and vermiculite as the substrate. In contrast, the present example reports experiments performed in a greenhouse using a non-sterilized agricultural soil as a substrate, to determine whether the cultivation system disclosed herein works equally well with a natural substrate. Although the experiments were performed in a greenhouse, the agricultural soil was not sterilized and therefore contained soil organisms, such as bacteria and fungi, that live naturally in the soil. The results presented below show that the cultivation system works efficiently with an agricultural soil as the substrate and phosphite as the phosphorus source.

An acidic agricultural soil was obtained from North Mexico. The soil has a low content of phosphorus, about 5 parts per million. The soil was used directly from the field, and was not sterilized. The soil is a sandy loam, composed of about 30% clay, 21% silt, and 49% sand, and is acidic, with a pH of 5.1. The soil has an electrical conductivity (milli-mhos per centimeter) of 0.20. The soil has 1.4% organic matter. Besides phosphorus, the soil has the following assimilable nutrients and minor elements (parts per million): nitrogen 5, potassium 100, iron 7, manganese 26, copper 0.2, and zinc 0.9. The soil has soluble cations and anions (milli-equivalents per liter) as follows: potassium 0.15, calcium 1.5, magnesium 0.5, sodium 0.5, bicarbonates 1.0, and chlorides 0.7.

A transgenic tobacco line, ptxDNt-80, was used for the experiments. The transgenic line has been modified genetically to express a bacterial phosphite oxidoreductase, namely, PtxD (SEQ ID NO:1). The soil was amended with 40, 60, or 80 parts per million of phosphorus by addition of phosphate or phosphite. Then, seeds from the transgenic and control lines were sowed on the soil. The growth of the transgenic line was measured at different days after germination.

FIG. 15 shows photographic data for the transgenic and control lines at 31 days after germination. FIG. 15A shows that very poor growth of the transgenic line or control line occurred if the soil was not amended with phosphorus (NO P). (Small plants are circled and identified with arrows.) FIG. 15B shows that the transgenic line fertilized with phosphite displayed similar development relative to the transgenic and control lines fertilized with phosphate.

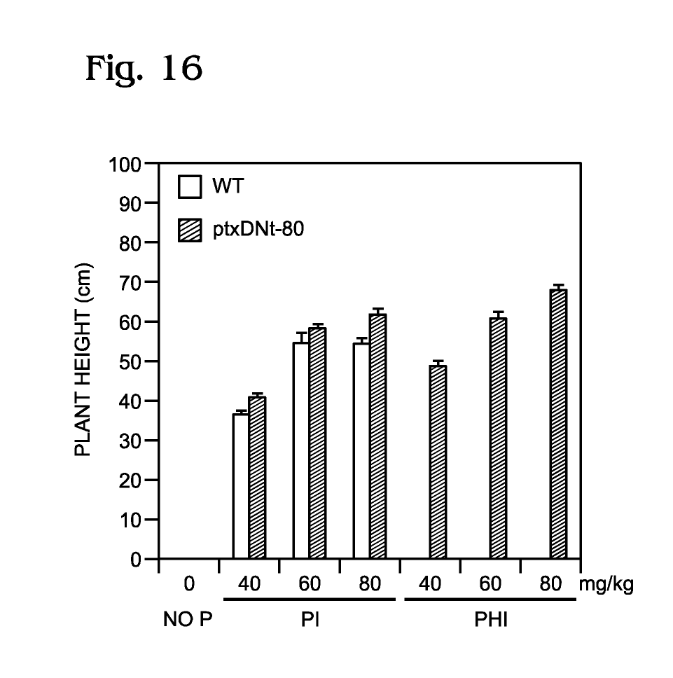

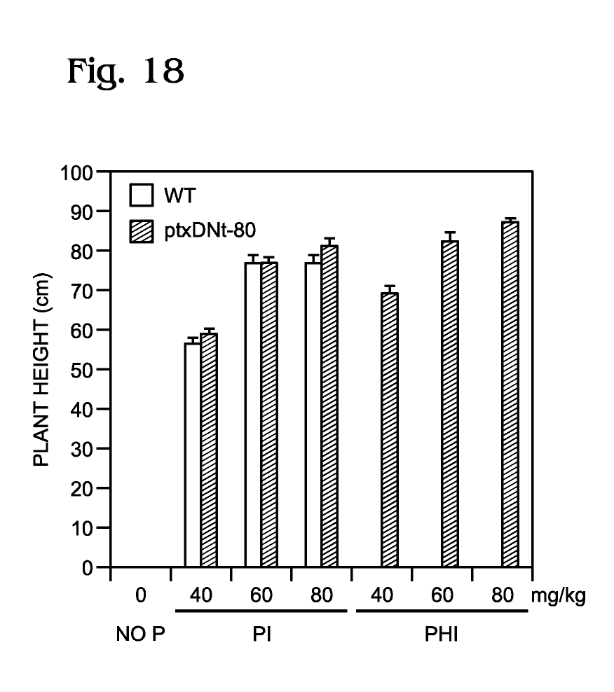

FIGS. 16-18 shows height and photographic data for the transgenic and control lines at 68 or 74 days after germination. The transgenic line fertilized with phosphite displayed a greater height than transgenic or control plants fertilized with phosphate (see FIGS. 16 and 18).

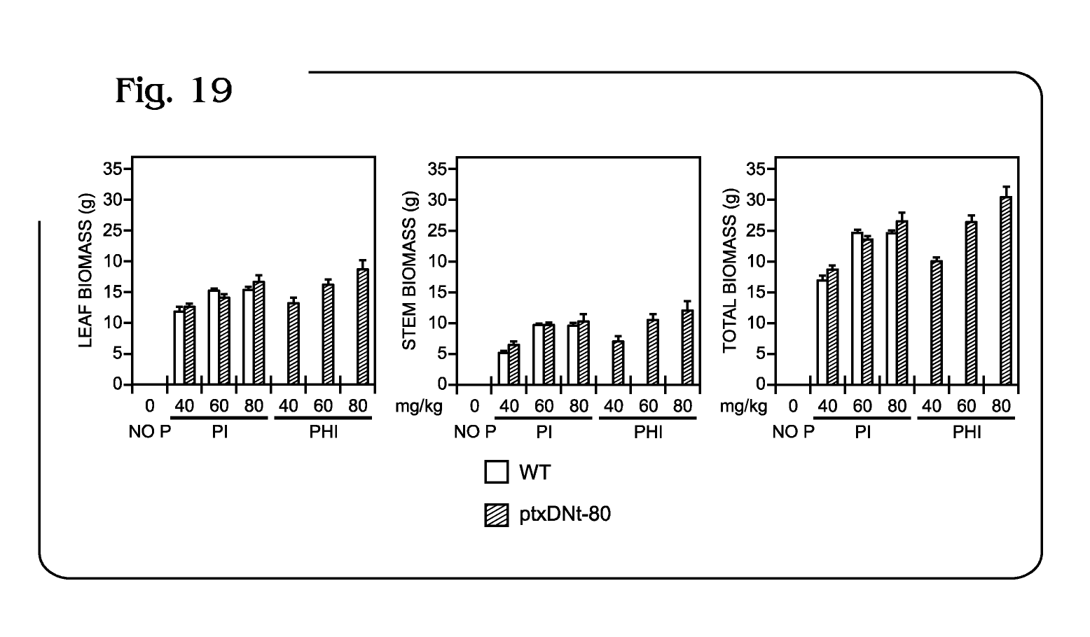

FIG. 19 presents exemplary data for the leaf biomass, stem biomass, and total biomass of the transgenic and control lines at 75 days after germination. The transgenic line fertilized with 80 parts per million phosphite produced a higher biomass of leaves and stems than either line fertilized with phosphate.

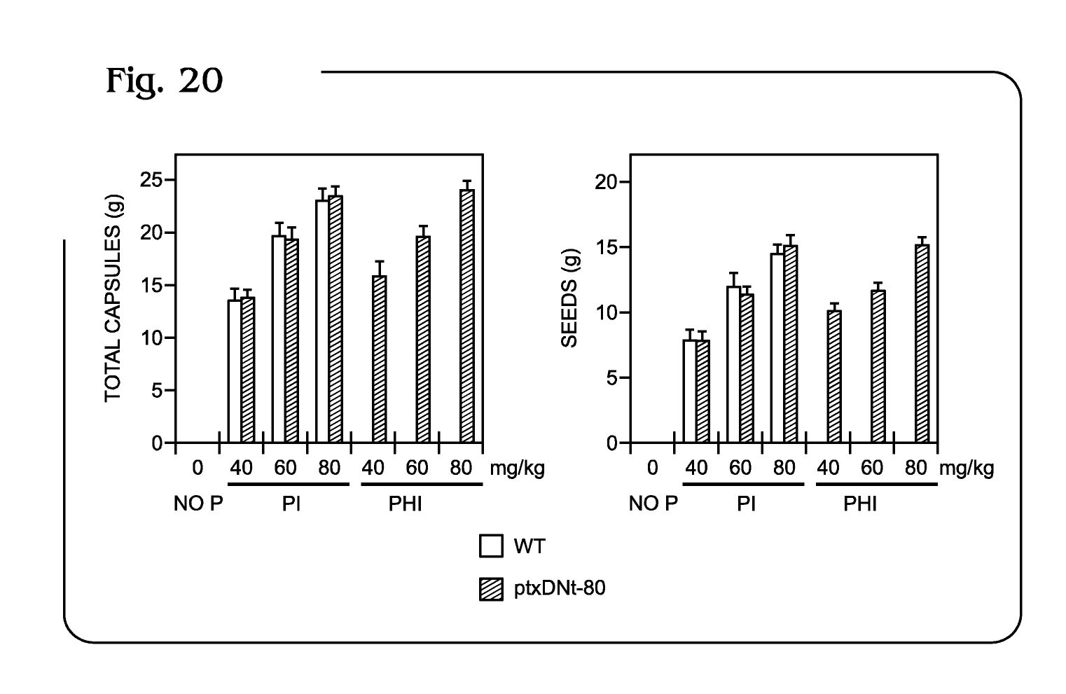

FIG. 20 presents data for the yield of capsules and seeds from the transgenic and control lines at four months after germination. The total production of capsules and seeds per plant was similar for the transgenic line fertilized with phosphite compared to either line fertilized with phosphate. However, when the soil was amended with only 20 parts per million phosphite, the transgenic line produced 33% more seeds than either line fertilized with the same amount of phosphate.

### Example 3

### Selected Embodiments

This example describes selected embodiments of the present disclosure as a series of numbered paragraphs.

1. A method of cultivating a transgenic plant that has been modified genetically to express an enzyme that catalyzes oxidation of phosphite to phosphate, the method comprising: (A) disposing the transgenic plant in a substrate having a content of available phosphate low enough to limit plant growth; and (B) applying an effective amount of phosphite to the substrate, and/or to foliage above the substrate, to enhance growth of the transgenic plant and to act as a weed-control agent that kills weeds and/or directly suppresses growth of weeds near the transgenic plant.

2. The method of paragraph 1, wherein the step of disposing the transgenic plant includes a step of disposing seeds, regenerative plant parts, and/or plantlets in and/or on the substrate, and wherein the seeds germinate, the plant parts regenerate, and/or the plantlets grow to produce specimens of the transgenic plant.

3. The method of paragraph 2, wherein the step of applying an effective amount of phosphite includes a step of applying phosphite before the step of disposing seeds, regenerative plant parts, and/or plantlets.

4. The method of paragraph 2, wherein the step of applying an effective amount of phosphite includes a step of applying phosphite after the step of disposing seeds, regenerative plant parts, and/or plantlets.

5. The method of paragraph 4, wherein the step of applying an effective amount of phosphite includes a step of applying phosphite before and a step of applying phosphite after the step of disposing seeds, regenerative plant parts, and/or plantlets.

6. The method of any preceding paragraph, wherein the substrate is soil having a content of available phosphate that is less than about 25 parts per million.

7. The method of any of paragraphs 1 to 5, wherein the substrate is an alkaline or acidic soil having a total content of phosphorus and/or phosphate of less than about 50 parts per million.

8. The method of any preceding paragraph, wherein the substrate is soil that produces a phosphate solution of less than about 20 micromolar when the soil is saturated with water.

9. The method of any of paragraphs 1 to 5, wherein the substrate is a liquid or semi-solid medium provided by a hydroponic system, and wherein the effective amount of phosphite suppresses growth of and/or kills algae in the medium.

10. The method of any preceding paragraph, further comprising a step of growing the transgenic plant after the step of disposing to produce a crop of the transgenic plant.

11. The method of any preceding paragraph, further comprising (1) a step of testing the substrate to determine a content of available phosphorus and/or phosphate, and (2) a step of selecting the effective amount of phosphite to apply to the substrate, and/or foliage above the substrate, based on the content of available phosphorus/phosphate determined.

12. The method of paragraph 11, wherein the step of selecting the effective amount of phosphite includes a step of selecting a larger amount of phosphite if the content is relatively higher or a smaller amount of phosphite if the content is relatively lower.

13. A method of cultivating a transgenic plant that has been modified genetically to express an enzyme that catalyzes oxidation of phosphite to phosphate, the enzyme being expressed at a level sufficient for the transgenic plant to use phosphite as a nutrient for growth, the method comprising: (A) disposing the transgenic plant in a substrate having a content of available phosphate that is not limiting for weed growth; and (B) applying an effective amount of phosphite to the substrate, and/or to foliage above the substrate, to act as a weed-control agent that kills weeds and/or directly suppresses growth of weeds near the transgenic plant.

14. The method of paragraph 13, wherein the effective amount of phosphite is greater than the content of available phosphorus.

15. A method of cultivating a transgenic plant that has been modified genetically to express an enzyme that catalyzes oxidation of phosphite to phosphate, the method comprising: (A) testing soil to determine a content of phosphorus; (B) selecting an effective amount of phosphite for use as a weed-control agent based on the content of phosphorus; (C) applying the effective amount of phosphite to the soil, and/or to foliage above the soil; and (D) growing the transgenic plant in the soil.

16. The method of paragraph 15, wherein the step of testing soil determines a content of available phosphorus and/or phosphate in the soil.

17. The method of paragraph 15 or 16, wherein the step of selecting an effective amount of phosphite includes a step of selecting a larger amount of phosphite if the content is relatively higher or a smaller amount of phosphite if the content is relatively lower.

18. A method of increasing the weed-control potency of phosphite for an area of soil, the method comprising: (A) cultivating a first crop of a transgenic plant in an area of soil, the transgenic plant being modified genetically to express an enzyme that catalyzes oxidation of phosphite to phosphate; (B) applying an effective amount of phosphite to the area of soil to enhance growth of the first crop and to provide a weed-control agent that kills weeds and/or directly suppresses growth of weeds near the transgenic plant; and (C) repeating the steps of cultivating and applying with a second crop of a transgenic plant modified genetically to express an enzyme that catalyzes oxidation of phosphite to phosphate.

19. The method of paragraph 18, wherein the transgenic plant cultivated in the first crop is a different species from the transgenic plant cultivated in the second crop.

20. The method of paragraph 18 or 19, wherein the effective amount of phosphite applied for the first crop is different from the effective amount of phosphite applied for the second crop.

21. The method of any of paragraphs 18 to 20, wherein less phosphite is applied for the second crop than for the first crop.

22. The method of any of paragraphs 18 to 21, wherein the area of soil has a content of available phosphorus and/or phosphate that is decreased by cultivating the first crop and decreased further by cultivating the second crop.

23. The method of paragraph 22, wherein a ratio of the effective amount of phosphite to the content of available phosphorus/phosphate is about the same for the first crop and the second crop.

24. The method of paragraph 22, wherein a ratio of the effective amount of phosphite to the content of available phosphorus/phosphate is greater for the second crop than for the first crop.

25. A method of hydroponically cultivating a transgenic plant that has been modified genetically to express an enzyme that catalyzes oxidation of phosphite to phosphate, the method comprising: culturing the transgenic plant in a liquid or semi-solid medium of a hydroponic system, with the medium containing an effective amount of phosphite to support growth of the plant and to act as an algae-control agent that kills algae and/or suppresses growth of algae in the medium.

26. The method of paragraph 25, wherein the medium is a semi-solid medium including an inert matrix.

27. The method of paragraph 25 or 26, wherein the step of culturing is performed in a greenhouse.

28. The method of any of paragraphs 25 to 27, wherein a nutrient solution forms at least part of the medium, and wherein the nutrient solution is disposed in a fluidics system that recirculates the nutrient solution.

29. The method of any of paragraphs 25 to 28, wherein the medium has a phosphorus/phosphate concentration of less than about 20 micromolar.

30. The method of any of paragraphs 25 to 28, wherein the medium has a phosphite concentration of greater than about 20 micromolar.

31. The method of any preceding paragraph, wherein the transgenic plant is genetically modified to express a bacterial phosphite oxidoreductase.

32. The method of paragraph 31, wherein the phosphite oxidoreductase is a phosphite dehydrogenase.

33. The method of paragraph 32, wherein the phosphite dehydrogenase is PtxD (SEQ ID NO:1).

The disclosure set forth above may encompass multiple distinct inventions with independent utility. Although each of these inventions has been disclosed in its preferred form(s), the specific embodiments thereof as disclosed and illustrated herein are not to be considered in a limiting sense, because numerous variations are possible. The subject matter of the inventions includes all novel and nonobvious combinations and subcombinations of the various elements, features, functions, and/or properties disclosed herein. The following claims particularly point out certain combinations and subcombinations regarded as novel and nonobvious. Inventions embodied in other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure. Further, ordinal indicators, such as first, second, or third, for identified elements are used to distinguish between the elements, and do not indicate a particular position or order of such elements, unless otherwise specifically stated.

1. A method of cultivating a transgenic plant that has been modified genetically to express an enzyme that catalyzes oxidation of phosphite to phosphate, the method comprising:
disposing the transgenic plant in a substrate having a content of available phosphate low enough to limit plant growth; and
applying an effective amount of phosphite to the substrate, and/or to foliage above the substrate, to enhance growth of the transgenic plant and to act as a weed-control agent that kills weeds and/or directly suppresses growth of weeds near the transgenic plant.

2. The method of claim 1, wherein the step of disposing the transgenic plant includes a step of disposing seeds, regenerative plant parts, and/or plantlets in and/or on the substrate, and wherein the seeds germinate, the plant parts regenerate, and/or the plantlets grow to produce specimens of the transgenic plant.

3. The method of claim 2, wherein the step of applying an effective amount of phosphite includes a step of applying phosphite before the step of disposing seeds, regenerative plant parts, and/or plantlets.

4. The method of claim 2, wherein the step of applying an effective amount of phosphite includes a step of applying phosphite after the step of disposing seeds, regenerative plant parts, and/or plantlets.

5. The method of claim 4, wherein the step of applying an effective amount of phosphite includes a step of applying phosphite before and a step of applying phosphite after the step of disposing seeds, regenerative plant parts, and/or plantlets.

6. The method of claim 1, wherein the substrate is soil having a content of available phosphorus and/or phosphate that is less than about 25 parts per million.

7. The method of claim 1, wherein the substrate is an alkaline or acidic soil having a total content of phosphorus and/or phosphate of less than about 50 parts per million.

8. The method of claim 1, wherein the substrate is soil that produces a phosphate solution of less than about 25 micromolar when the soil is saturated with water.

9. The method of claim 1, wherein the substrate is a liquid or semi-solid medium provided by a hydroponic system, and wherein the effective amount of phosphite suppresses growth of and/or kills algae in the medium.

10. The method of claim 1, wherein the substrate is soil, further comprising a step of growing the transgenic plant after the step of disposing to produce a crop of the transgenic plant.

11. The method of claim 1, further comprising (1) a step of testing the substrate to determine a content of phosphorus, and (2) a step of selecting the effective amount of phosphite to apply to the substrate, and/or foliage above the substrate, based on the content of phosphorus determined.

12. The method of claim 11, wherein the step of selecting the effective amount of phosphite includes a step of selecting a larger amount of phosphite if the content of phosphorus is relatively higher or a smaller amount of phosphite if the content of phosphorus is relatively lower.

13. The method of claim 11, wherein the content of phosphorus is a content of available phosphate of the substrate.

14. The method of claim 1, wherein the transgenic plant is genetically modified to express a bacterial phosphite oxidoreductase.

15. The method of claim 14, wherein the phosphite oxidoreductase is a phosphite dehydrogenase.

16. The method of claim 15, wherein the phosphite dehydrogenase is PtxD (SEQ ID NO:1).

17. A method of cultivating a transgenic plant that has been modified genetically to express an enzyme that catalyzes oxidation of phosphite to phosphate, the enzyme being expressed at a level sufficient for the transgenic plant to use phosphite as a nutrient for growth, the method comprising:
disposing the transgenic plant in a substrate having a content of available phosphate that is not limiting for weed growth; and
applying an effective amount of phosphite to the substrate, and/or to foliage above the substrate, to act as a weed-control agent that kills weeds and/or directly suppresses growth of weeds near the transgenic plant.

18. The method of claim 17, wherein the effective amount of phosphite is greater than the content of available phosphate.

19. A method of cultivating a transgenic plant that has been modified genetically to express an enzyme that catalyzes oxidation of phosphite to phosphate, the method comprising:
testing soil to determine a content of phosphorus;
selecting an effective amount of phosphite for use as a weed-control agent based on the content of phosphorus;
applying the effective amount of phosphite to the soil, and/or to foliage above the soil; and
growing the transgenic plant in the soil.

20. The method of claim 19, wherein the step of testing soil determines a content of available phosphate in the soil.

21. The method of claim 19, wherein the step of selecting an effective amount of phosphite includes a step of selecting a larger amount of phosphite if the content of phosphorus is relatively higher or a smaller amount of phosphite if the content of phosphorus is relatively lower.

22. A method of increasing the weed-control potency of phosphite for an area of soil, the method comprising:
cultivating a first crop of a transgenic plant in an area of soil, the transgenic plant being modified genetically to express an enzyme that catalyzes oxidation of phosphite to phosphate;
applying an effective amount of phosphite to the area of soil to enhance growth of the first crop and to provide a weed-control agent that kills weeds and/or directly suppresses growth of weeds near the transgenic plant; and
repeating the steps of cultivating and applying with a second crop of a transgenic plant modified genetically to express an enzyme that catalyzes oxidation of phosphite to phosphate.

23. The method of claim 22, wherein the transgenic plant cultivated in the first crop is a different species from the transgenic plant cultivated in the second crop.

24. The method of claim 22, wherein the effective amount of phosphite applied for the first crop is different from the effective amount of phosphite applied for the second crop.

25. The method of claim 24, wherein less phosphite is applied for the second crop than for the first crop.

26. The method of claim 22, wherein the area of soil has a content of available phosphate that is decreased by cultivating the first crop and decreased further by cultivating the second crop.

27. The method of claim 26, wherein a ratio of the effective amount of phosphite to the content of available phosphate is about the same for the first crop and the second crop.

28. The method of claim 26, wherein a ratio of the effective amount of phosphite to the content of available phosphate is greater for the second crop than for the first crop.

29. A method of hydroponically cultivating a transgenic plant that has been modified genetically to express an enzyme that catalyzes oxidation of phosphite to phosphate, the method comprising:
culturing the transgenic plant in a liquid or semi-solid medium of a hydroponic system, with the medium containing an effective amount of phosphite to support growth of the plant and to act as an algae-control agent that kills algae and/or suppresses growth of algae in the medium.

30. The method of claim 29, wherein the medium is a semi-solid medium including an inert matrix.

31. The method of claim 29, wherein the step of culturing is performed in a greenhouse.

32. The method of claim 29, wherein a nutrient solution forms at least part of the medium, and wherein the nutrient solution is disposed in a fluidics system that recirculates the nutrient solution.

33. The method of claim 29, wherein the medium has a phosphate concentration of less than about 20 micromolar.

34. The method of claim 29, wherein the medium has a phosphite concentration of greater than about 20 micromolar.
